(19) United States
(12) Patent Application Publication
(10) Pub. No.: US 2026/0225810 A1
(43) Pub. Date: Aug. 6, 2026

(54) HIGH THROUGHPUT WORKSTATIONS AND METHODS OF USE

(71) Applicant: Symbotic LLC, Wilmington, MA (US)

(72) Inventors: Mary Lucia L. Barnard, Londonderry, NH (US); William J. Fosnight, Windham, NH (US); David B. Simpson, Fort Mill, SC (US); Michael W. Chesna, Saugus, MA (US); Alan J. Grant, Nashua, NH (US); Frederick M. Morgan, Bedford, NH (US); Derek J. McGearty, Lowell, MA (US)

(21) Appl. No.: 19/042,636

(22) Filed: Jan. 31, 2025

(51) Int. Cl. B65G 1/137; B65G 1/06

(52) U.S. Cl. CPC B65G 1/1378; B65G 1/065

(57) ABSTRACT

A system, comprising: mobile robots; a storage structure accessible by the mobile robots and configured to store a container of the containers; workstations accessible by the mobile robots; and a first transit deck; wherein each of the workstations comprises: a first set of one or more substations in a first orientation, and a second set of one or more substations in a second orientation, wherein each substation of the first and second sets of one or more substations comprises a respective access port accessible by the mobile robots and configured to enable a respective container to be exposed through the access port; and an access area defined by boundaries of both of the first set of one or more substations and the second set of one or more substations.

### TECHNICAL FIELD

This disclosure relates generally to controlling robots in controlling inventory.

### BACKGROUND

The management of inventory can be critical to the operation of many industries. Some industries use systems to move inventory. There is a need to improve the control and distribution of inventory.

### BRIEF DESCRIPTION OF DRAWINGS

Disclosed herein are embodiments of systems, apparatuses and methods pertaining controlling robots in controlling inventory. This description includes drawings, wherein:

FIG. 1A illustrates a perspective view of at least a portion of an example container storage facility with an example container storage and retrieval system of an example storage and retrieval system that utilizes mobile robots to travel through a three-dimensional matrix of container storage locations, in accordance with some embodiments.

FIG. 1B illustrates an overhead view of a portion of an example storage structure 104, in accordance with some embodiments.

FIG. 2A illustrates a perspective view of an example container storage and retrieval system with example workstations, in accordance with some embodiments.

FIG. 2B illustrates a perspective view of an example workstation, in accordance with some embodiments.

FIG. 2C illustrates a perspective view of an example workstation, in accordance with some embodiments.

FIG. 3 illustrates a block diagram, overhead view of an example workstation, in accordance with some embodiments.

FIG. 4A illustrates a block diagram, overhead view of an example workstation of FIG. 2A-2B, in accordance with some embodiments.

FIG. 4B illustrates a block diagram, overhead view of an example workstation cooperated with transit decks, in accordance with some embodiments.

FIG. 4C illustrates a perspective view of an example workstation, in accordance with some embodiments.

FIG. 5 illustrates a block diagram, partially transparent, plane view of an example workstation, in accordance with some embodiments.

FIG. 6 illustrates a block diagram, partially transparent, perspective view of an example workstation, in accordance with some embodiments.

FIG. 7 illustrates a illustrates a perspective view of example workstations of a container storage and retrieval system that are positioned external to the storage structure and spaced along an exterior of the storage structure, in accordance with some embodiments.

FIG. 8A illustrates a block diagram, overhead view of example workstations cooperated with a storage structure, in accordance with some embodiments.

FIG. 8B illustrates a block diagram, zoomed in view of an example workstation of FIG. 7, in accordance with some embodiments.

FIG. 9 illustrates an overhead, perspective view of example workstations of a container storage and retrieval system that are positioned external to the storage structure, in accordance with some embodiments.

FIG. 10 illustrates an overhead view of a lower station level of a workstation cooperated with a storage structure of a container storage and retrieval system, in accordance with some embodiments.

FIG. 11 illustrates an overhead view of an upper station level of the workstation of FIG. 10, in accordance with some embodiments.

FIG. 12 illustrates an overhead, perspective view of example workstations, of a container storage and retrieval system, that are positioned external to the storage structure, in accordance with some embodiments.

FIG. 13 illustrates an overhead, perspective view of an example workstation positioned external to the storage structure, in accordance with some embodiments.

FIG. 14 illustrates an overhead, perspective view of a portion of an example workstation, in accordance with some embodiments.

FIG. 15A illustrates a block diagram plane view of an example workstation with a first set of one or more of substations, a second set of one or more substations with multiple access ports, and a third set of one or more substations with multiple access ports, in accordance with some embodiments.

FIG. 15B illustrates a block diagram plane view of an example workstation with a first set of one or more of substations, and a second set of one or more substations with multiple access ports, in accordance with some embodiments.

FIG. 16 illustrates a block diagram overhead plane view of an example workstation, in accordance with some embodiments.

FIG. 17 illustrates an overhead perspective view of an example workstation of an example container storage and retrieval system, in accordance with some embodiments.

FIG. 18 illustrates a flow diagram of an example process of controlling inventory and fulfilling orders, in accordance with some embodiments.

FIG. 19 illustrates a flow diagram of an example process of controlling inventory through the control of mobile robots in a storage and retrieval system, in accordance with some embodiments.

FIG. 20 illustrates a flow diagram of an example process of positioning a container within a substation of a workstation, in accordance with some embodiments.

FIG. 21 illustrates an example system for use in implementing methods, techniques, devices, apparatuses, systems, servers, processors, microprocessors, processing systems, sources and providing product order fulfillment, decanting, consolidation and inventory management, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

Automated systems are provide access areas that are defined by multiple sets of one or more access ports that enable greater access to containers in order fulfillment, product dispensing, product decanting and ingestion, order assembly, product and/or sub-tote consolidation, and/or other applications. Further, some embodiments provide enhanced workstations that greatly improve the operational efficiency of an automated inventory management and storage and retrieval system, reduce latency in access to products, reduce robot traffic, increase reliability of robots and access to products, enable streamlining of routing of mobile robots between access ports and/or workstations, and other such benefits.

Generally speaking, pursuant to various embodiments, some embodiments provide automated container storage and retrieval systems, comprising: mobile robots configured to transport containers configured to support products; a storage structure accessible by the mobile robots, wherein the storage structure comprises multiple vertically spaced levels that each comprise multiple aisles, wherein each of the multiple aisles comprise storage locations configured to store a container of the containers; workstations cooperated with the storage structure and accessible by the mobile robots, wherein the workstations are spaced at different locations along the storage structure; and a first transit deck cooperated between the storage structure and a first workstation of the workstations, wherein the first transit deck comprises a planar surface upon which the mobile robots transport the containers establishing a planar route between the storage structure and the first workstation. Each of the workstations can comprise: a first set of one or more substations positioned in a first orientation that is substantially parallel with a first axis of the storage structure, and a second set of one or more substations positioned in a second orientation that is different than the first orientation along a second axis that is at a first angle to the first axis of the storage structure, wherein each substation of the first and second sets of one or more substations comprises a respective access port accessible by the mobile robots and configured to enable a respective container, of the containers, to be exposed through each of the respective access ports allowing a product to be inserted and/or removed; and an access area defined by boundaries of both of the first set of substations and the second set of substations, with the first and second sets of one or more substations positioned such that each access port of the first and second sets of one or more substations are accessible by a picker from the access area.

Some embodiments provide methods of controlling inventory, comprising: identifying an allocation of products within a storage structure, the storage structure comprising: workstations are spaced at different locations along the storage structure, multiple vertically spaced levels that each comprise multiple aisles, wherein each of the multiple aisles comprise storage locations configured to store at least one container of containers; directing, by a control circuit, a first mobile robot, of mobile robots, to transport containers through the storage structure and to or from a first workstation, of the workstations cooperated with the storage structure and accessible by the mobile robots, wherein the first mobile robot: accessing and traveling along a first transit deck, comprising a planar surface, that is cooperated between the storage structure and the first workstation; and accessing a first access port of one of a first set of one or more substations positioned in a first orientation that is substantially parallel with a first axis of the storage structure and a second set of one or more substations positioned in a second orientation that is different than the first orientation along a second axis that is at a first angle to the first axis of the storage structure, and defining an access area bounded by both of the first set of substations and the second set of substations, with the first and second sets of one or more substations positioned such that each access port of the first and second sets of one or more substations are accessible by a picker from the access area, wherein each substation of the first and second sets of one or more substations comprises a respective access port that is accessible by the mobile robots and configured to enable a respective container, of the containers, to be exposed through each of the respective access ports allowing a product to be inserted and/or removed by the picker.

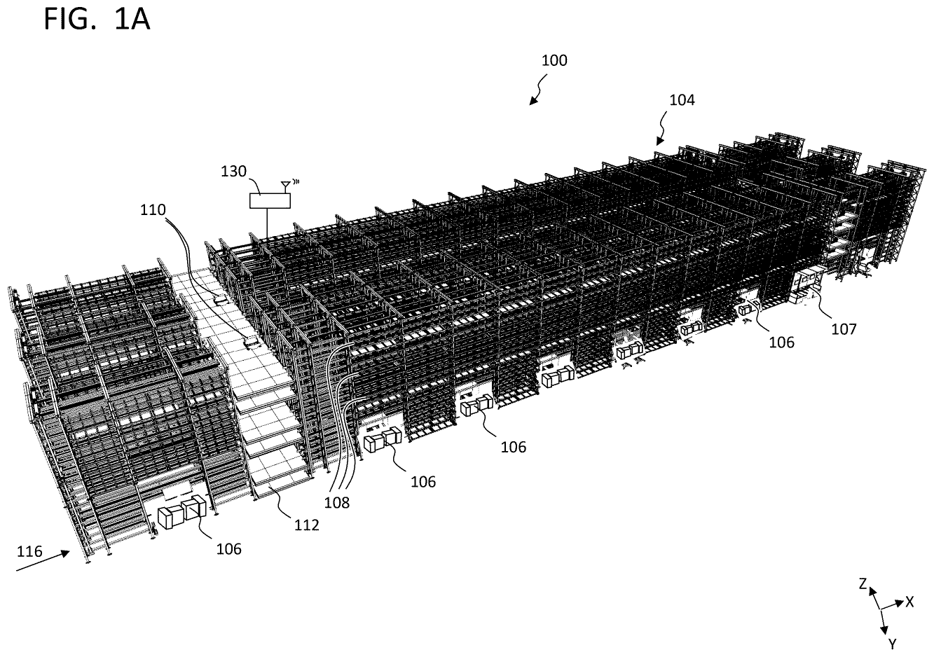

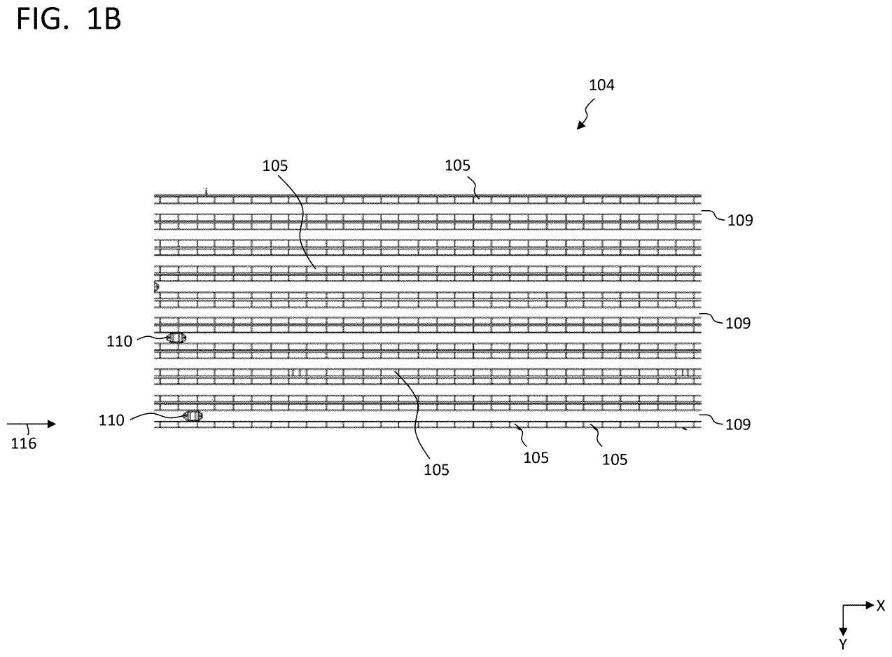

FIG. 1A illustrates a perspective view of at least a portion of an example container storage facility with an example container storage and retrieval system 100 of an example automated container storage and retrieval system that utilizes mobile robots 110 to travel through the three-dimensional (3D) matrix of container storage locations 105, in accordance with some embodiments. FIG. 1B illustrates an overhead view of a portion of an example storage structure 104, in accordance with some embodiments. Referring to FIGS. 1A-1B, the container storage and retrieval system 100 and the disclosed example embodiments may have features as described and/or may have in any suitable combination features as described in U.S. Pat. No. 9,139,363, entitled “Automated Systems for Transporting Payloads”, U.S. Pat. No. 10,435,241 entitled “Storage and Retrieval System”, and U.S. Pat. No. 11,142,398 entitled “Storage and retrieval system”, each of which is hereby incorporated by reference in its entirety; and U.S. Patent Application Publication No. 2023/0095494 entitled “Automatic Storage and Retrieval System having Staging and Sequencing Buffer Locations and Segregated Storage”, which is hereby incorporated by reference in its entirety. The container storage and retrieval system 100 includes at least one storage structure 104 accessible by mobile robots 110. Mobile robots 110 can be configured to transport containers, which can be configured to support and/or temporarily retail products, through the storage structure. Containers (e.g., totes, boxes, trays and/or other such product storage devices) can be transported and/or transferred by autonomous mobile robots 110.

In some embodiments, a storage structure 104 can be assembled with structural support to establish the 3D matrix of container storage locations 105 that store containers. The mobile robots 110 can operate and move in three dimensions throughout the storage and retrieval system 100 to transport containers throughout the storage and retrieval system along tracks, vertical channels, structure transit decks 112, ramps and/or other sub-structures of the storage and retrieval system 100. The operation and movement of the mobile robots is further described in U.S. Pat. Nos. 9,139,363; 10,435,241; and 11,142,398. The storage and retrieval system 100 can further include one or more types of workstations 106-107. In some embodiments, two or more workstations 106-107 can be cooperated with the storage structure 104 and spaced at different locations along one or more of the lengths and/or widths of the storage structure. At least some of the workstations can be accessed by the mobile robots 110. Some of the workstations 106-107 can be integrated into and positioned within the storage structure 104, and can be accessed by the mobile robots 110 directly from within the matrix of tracks, vertical tower channels, ramps, ramps and/or other such structures of the storage structure 104. Other workstations 106-107 may be part of and/or physically cooperated the storage structure through one or more planar transit decks, and in many instances by multiple levels of transit decks.

The storage structure provides the 3D array or grid of container storage locations 105 to receive and store containers transported by the mobile robots 110. In some embodiments, the storage structure 104 can include multiple vertically spaced levels 108, with multiple vertical tower channels that can be engaged by the mobile robots in self-propelling vertically within the storage structure 104 and establishing vertical paths between the multiple levels. Multiple aisles 109 can extend through the storage structure 104 and each aisle 109 can comprise tracks extending along some or all of a length of a respective aisle and along which mobile robots are supported while travelling along an aisle. The container storage locations 105 can be provided at the multiple levels and can be positioned along one or both sides of each of the multiple aisles. At least some of the storage locations can have predefined widths, heights and depths that correspond to dimensions of the containers and can store a container or containers delivered by the mobile robots 110 and retrieved by the mobile robots. The storage structure 104, container storage locations 105, the tracks and the movement of the mobile robots 110 through the storage and retrieval system 100 can be similar to those described in U.S. Pat. Nos. 9,139,363; 10,435,241; and 11,142,398. Some embodiments include one or more control circuits 130 and/or systems implemented through one or more processors, one or more microprocessors, one or more computers, one or more servers, one or more control logic, one or more code sets, one or more software, one or more network equipment, other such control systems, or a combination of two or more of such control systems that can be communicatively coupled over one or more distributed wired and/or wireless communication and/or computer networks (e.g., local area network (LAN), wide area network (WAN), the Internet, cellular networks, local wireless networks (e.g., Bluetooth, Wi-Fi, ZigBee, etc.), LoRa, LoRa-WAN, other such networks, or a combination of two or more of such networks) with the mobile robots 110, workstations 106-107, worker communication devices (e.g., headsets, smartphones, smartwatches, other wearable systems, computers, laptops, tablets, etc.), customer communication devices (e.g., smartphones, wearable systems, computers, laptops, tablets, etc.), remote databases (e.g., inventory databases, suppliers, delivery vehicles, drones, etc.), order management systems, inventory system, databases (e.g., inventory database(s), customer database(s), supplier database(s), manufacturer database(s), product information database(s), maintenance database(s), etc.), delivery control system, other system components, and typically a combination of two or more of such system components. The system may further include and/or be in communication via the one or more distributed computer and/or communications networks with user computing systems (e.g., computers, laptops, smartphones, tablets, user wearable systems, etc.), order management systems, inventory system, databases, delivery control system, and/or other such system components of an order fulfillment entity and/or facility, retailer and/or other such entities.

Still referring to FIGS. 1A-1B, the workstations 106 can, in some embodiments, be part of and/or formed within the storage structure 104. Further, in some implementations, the workstations are configured with a predefined dimensions to be consistent with a predefined number of container storage locations 105, and in some embodiments have dimensions to occupy a volume within the storage structure 104 that is equal to a predefined number of container storage locations. One or more of the workstations can be utilized for dispense, decant, order assembly, consolidation and/or other applications within the storage and retrieval system 100, enable picking with product containers presented and products retrieved from product containers in fulfilling orders (e.g., placing picked products into bags, order containers, etc.), and/or other operations.

At least some of the workstations can comprise dynamic workstations 106 that enhance the container transfer process, reduce traffic, increase throughput and improve container distribution. Further, some workstations 106 are configured to enable the containers to remain on the mobile robots 110 as the mobile robots self-propel through the workstation and thus transporting the containers through the workstations. Dispensing processes, in some implementations, can occur where robots 110 can be sequentially presented at a workstation 106 with filled order containers where orders of multi-eaches can be transferred efficiently to shopping carts, bags, other containers, directly to customers and/or other such methods. Decanting processes, in some implementations, can occur where mobile robots can be sequentially moved through a workstation with one or more eaches, which can be used as inventory for subsequent order fulfillment, can be deposited into product containers. Dynamic workstations 106 can, in some embodiments, be used for picking where product containers are presented with items to be retrieved and placed into an order container (e.g., totes, cartons, bags, boxes, other such order containers, or a combination of two or more of such containers), which may be presented to a picker 207 (e.g., human, picking robot, telescoping transfer arms, etc.) from within the workstation, and/or containers external to the workstation.

In some embodiments, the workstations 106 are within and/or cooperated with the storage structure. The robots 110 can typically directly access the workstations from within the storage structure without leaving the storage structure and/or can travel along one or more transit decks extending from the storage structure to the workstation providing robotic paths to and from the workstations. This can greatly increase the throughput, reduce the number of mobile robots 110 utilized and reduce time between storage locations and the workstations for at least some implementations.

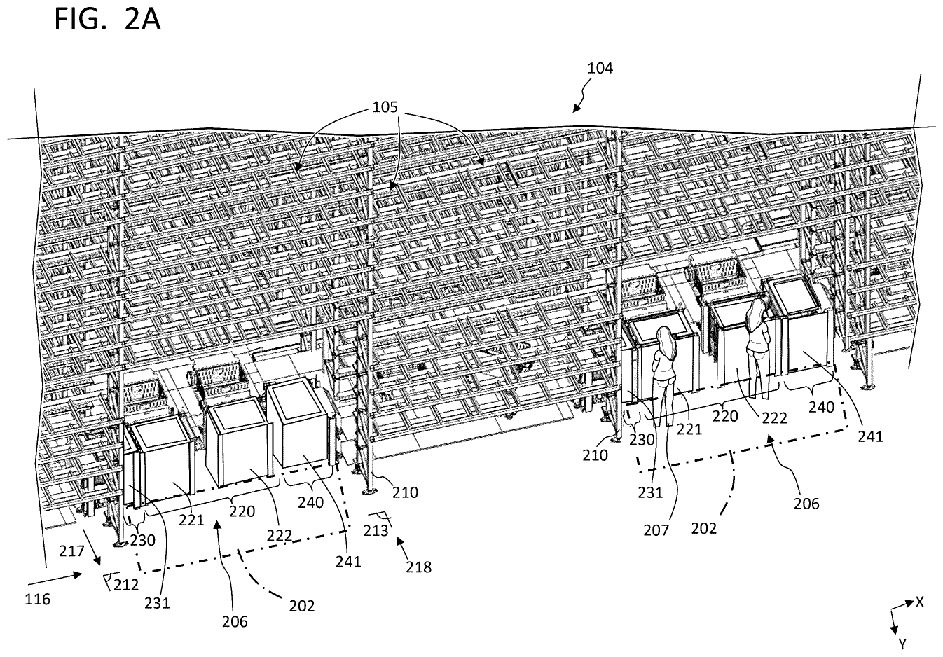

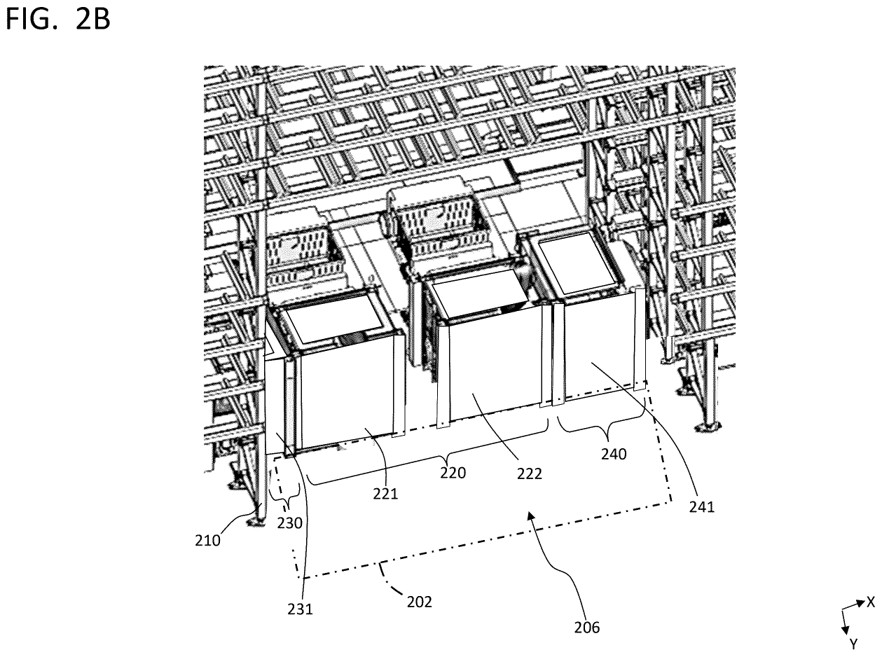

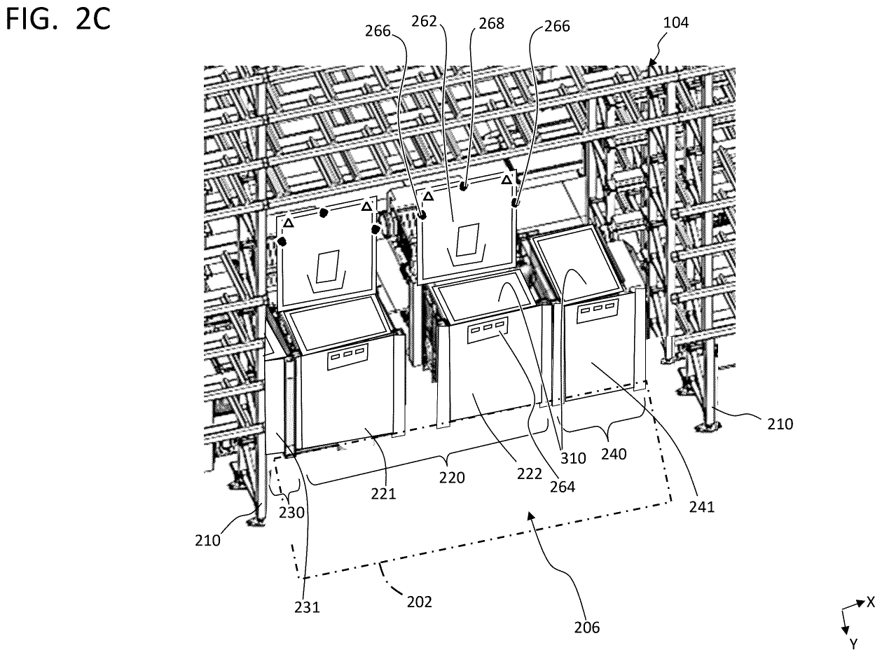

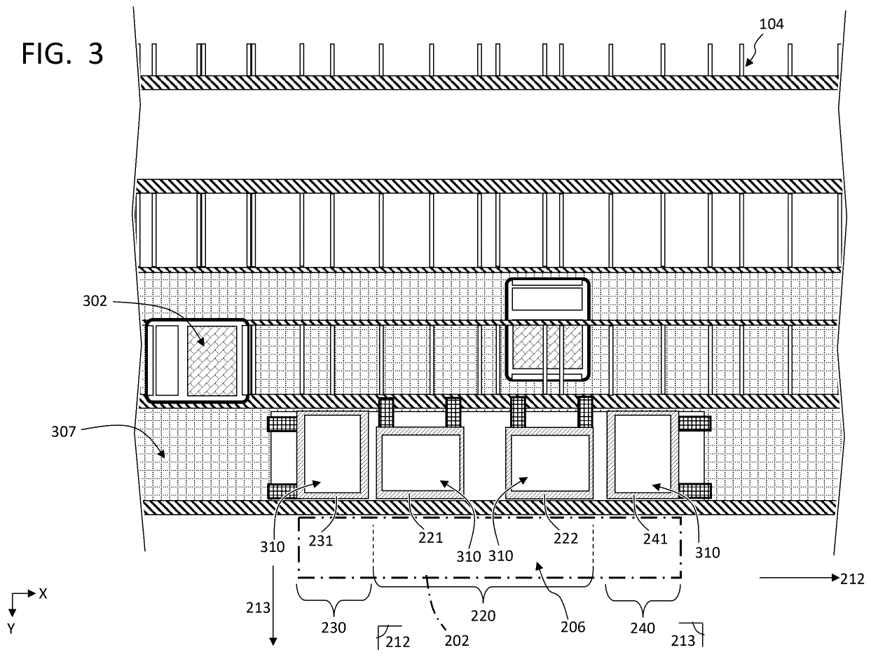

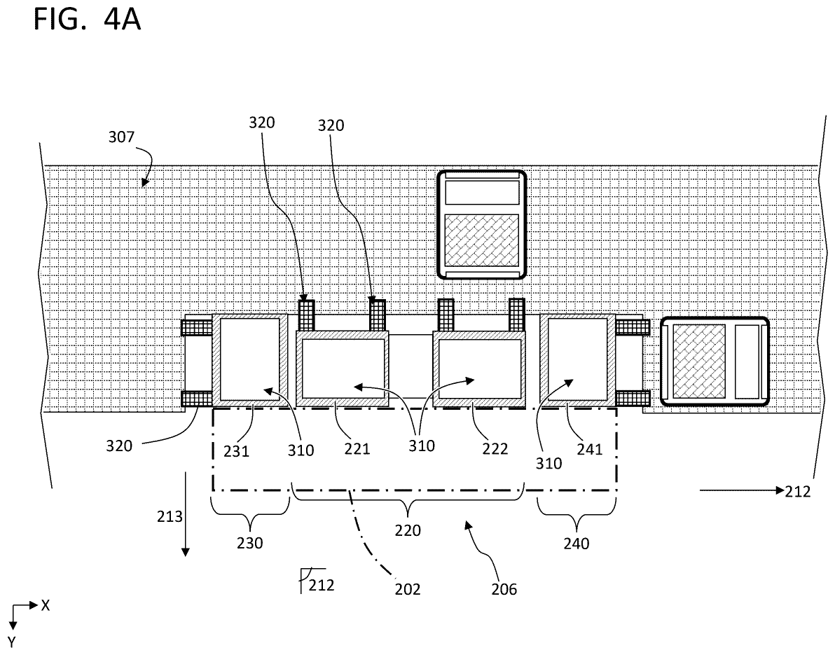

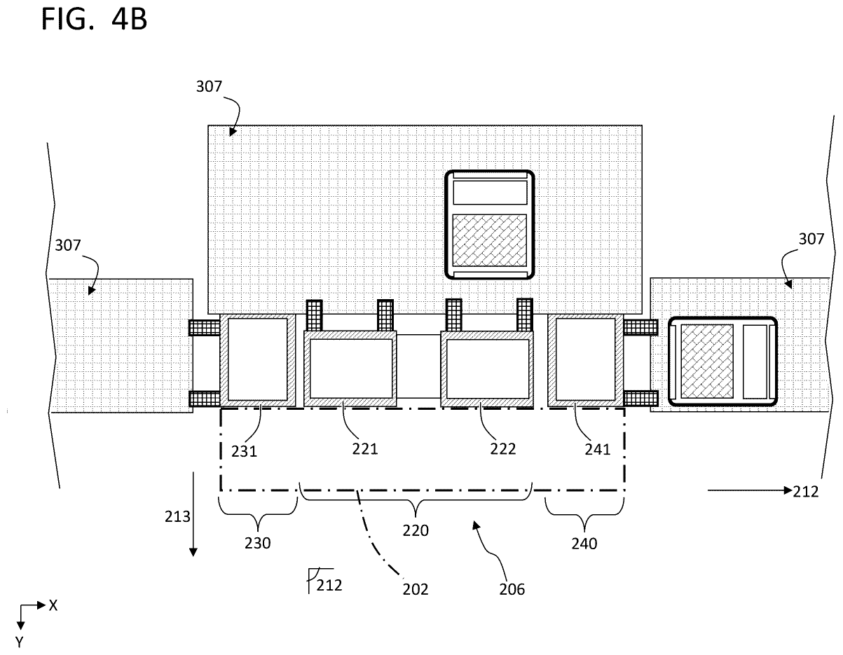

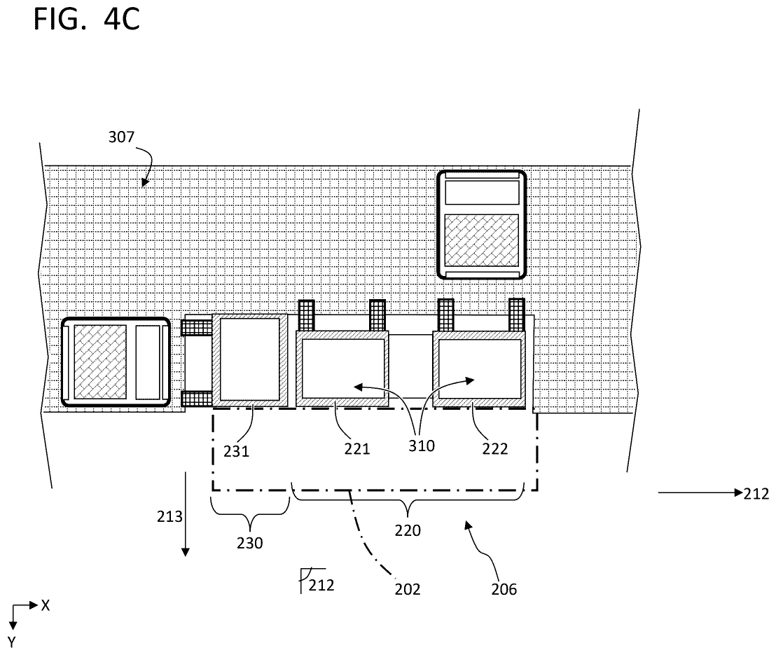

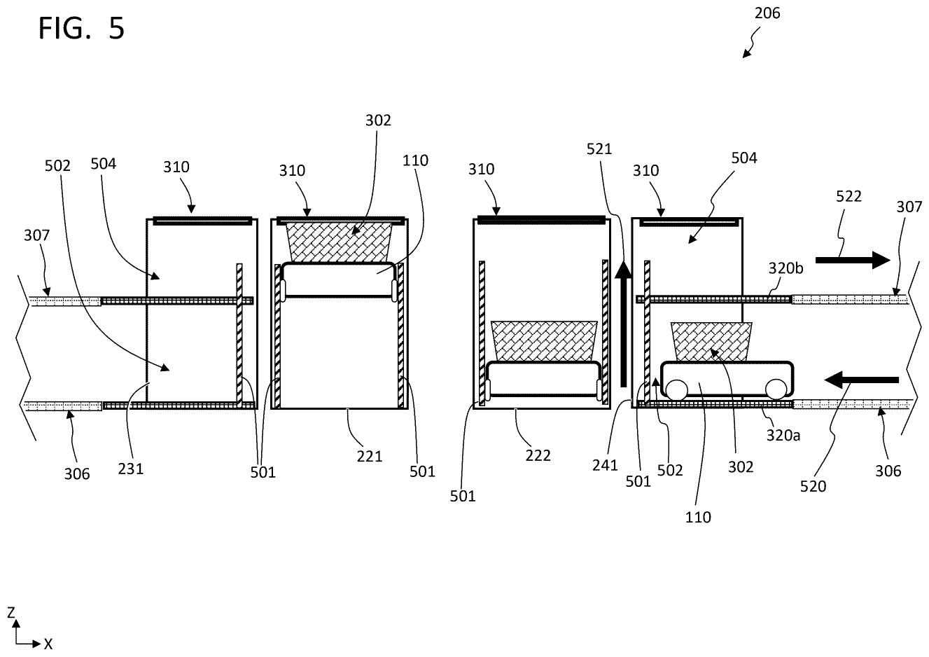

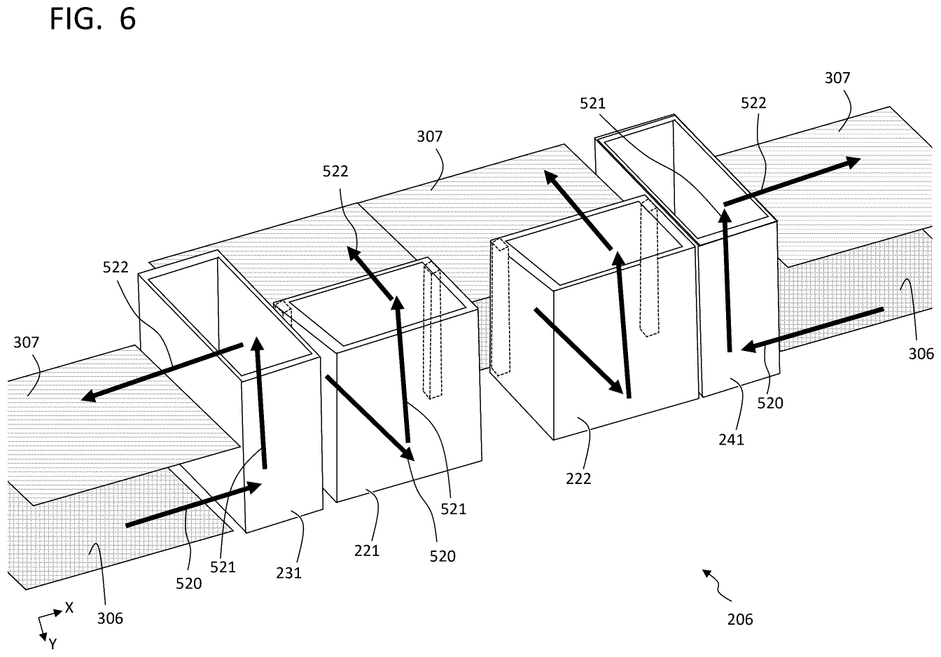

FIG. 2A illustrates a perspective view of an example container storage and retrieval system with example workstations, in accordance with some embodiments. FIG. 2B illustrates a perspective view of an example workstation 206, in accordance with some embodiments. FIG. 2C illustrates a perspective view of an example workstation 206, in accordance with some embodiments. FIG. 3 illustrates a block diagram, overhead view of an example workstation 206 of FIG. 2A-2B, in accordance with some embodiments. FIG. 4A illustrates a block diagram, overhead view of an example workstation 206 of FIG. 2A-2B, without illustrating the storage structure 104 for simplicity, in accordance with some embodiments. FIG. 4B illustrates a block diagram, overhead view of an example workstation 206 cooperated with transit decks 307, in accordance with some embodiments. FIG. 4C illustrates a perspective view of an example workstation 206, in accordance with some embodiments. FIG. 5 illustrates a block diagram, partially transparent, plane view of an example workstation 206 of FIG. 2A-2B, in accordance with some embodiments. FIG. 6 illustrates a block diagram, partially transparent, perspective view of an example workstation 206 of FIG. 2A-2B, in accordance with some embodiments. Referring to FIGS. 2A-6, as introduced above in some embodiments one or more workstations 206 can be positioned at least partially and often fully embedded within the dimensions of the storage structure 104. The workstations 206 can be sized to have a total width to be consistent with and/or fit within a predefined number of storage locations 105, such as a total number of storage locations positioned between vertical support frames 210 of the storage structure 104. As introduced above, in some embodiments, multiple workstations 206 are spaced along a dimension (e.g., a length and/or width) of the storage structure 104. While FIG. 2A shows two workstations 206, it will be appreciated that fewer or more than two workstations can be cooperated with the storage structure 104. The workstations 206 can include a first set 220 of one or more substations 221-222. The first set 220 of substations 221-222 can be positioned in a first orientation that is substantially parallel with a first axis 116 (e.g., a length) of the storage structure 104. A second set 230 of one or more substation 231 can be positioned in a second orientation that is different than the first orientation, such as along a second axis 217, that is at an angle 212 to the first axis 116 of the storage structure. The angle 212, in some embodiments, is perpendicular with a substation 231 extending into the storage structure 104. While the example angles are illustrated as perpendicular, it will be appreciated that other angles may be utilized depending on an intended implementation and/or operation.

In some embodiments, one or more workstations 206 may include one or more additional sets of substations, such as a third set 240 of one or more substations 241. The substations 241 of the third set 240 can, in some embodiments, be oriented opposite the second set 230 of one or more substations 231 (and in some instances a mirrored orientation to the second set 230 of substations 231), and along a third axis 218 that is at a second angle 213 to the first axis 116 of the storage structure. The second angle may be substantially any relevant angle, and in some instances is 180 degrees to the first angle 212.

Still referring to FIGS. 1-6, each substation 221-222, 231, 241 of the first, second and third sets 220, 230, 240 of one or more substations comprises a respective access port 310. The access port provides access by a picker 207, from exterior of the substation, to an interior of the substation. Some substations are configured such that the respective access port 310 is further configured to enable a respective container to be positioned relative to the access port and be exposed through each of the respective access ports allowing one or more products to be inserted into and/or removed from the positioned container. In some embodiments, the substations are configured with the respective access port 310 being further accessible by the mobile robots 110 that can position a respective container relative to the access port to be exposed through the respective access port allowing one or more products to be inserted into and/or removed from the container. One or more or all of the substations 221-222, 231, 241, in some embodiments, can include one or more substation vertical channels 501 that are configured to be engaged by the mobile robots enabling the mobile robots to self-propel vertically within the substation to position a container being transported by the mobile robot to at least partially align an opening of the container with the access port 310 of the substation. The substation vertical channels 501 can be the same as and/or have a similar configuration as the vertical channels of the storage structure 104 (e.g., as described in U.S. Pat. Nos. 9,139,363, 10,435,241, and 11,142,398, U.S. Publication No. 2023/0095494, and U.S. Provisional Application No. 63/626,967, filed Jan. 30, 2024, and entitled Retail Fulfillment Dispense and Decant Systems and Methods, each of which is hereby incorporated by reference in its entirety, such as includes one or more sets of teeth, gear rack, chain, cable, other such structures, or a combination of two or more of such structures).

In some embodiments, the first set 220 of substations includes two or more substations 221, 222, while the second set 230 of substations includes one substation 231, and the third set 240 of substations includes one substation 241. The substation 231 of the second set 230, in some embodiments, can be oriented 90 degrees relative to the orientation of the substations 221, 222 of the first set 220 of substations. Similarly, in some embodiments that include a third set 240 of substations, the substation 241 of the third set 230 can in some implementations be oriented 90 degrees relative to the orientation of the substations 221, 222 of the first set 220 of substations, and 180 degrees relative to the substation 231 of the second set 230 of substations.

Further, the first and second sets 220, 230 (and third set 240 when included) of substations can be cooperated with the storage structure 104, in some embodiments, to be at least partially, and typically fully embedded within the storage structure. For example, in some embodiments, the first set 220 of substations 221-222 can have an access or pick side facing away from the storage structure 104 and substantially aligned with and/or recessed from an exterior boundary of the storage structure. Similarly, substations of one or both of the second set 230 the third set 240 of one or more substations can be positioned within the storage structure. Additionally, in some implementations when partially or fully embedded, the sets 220, 230, 240 of substations can be sized and oriented to fit within a predefined space, such as a space equal to a predefined set of storage locations 105. In some embodiments, access sides of the first set 220 of workstations can be substantially aligned with access sides of the substations of the second set 230 and third set 240 of the substations.

In some embodiments, one or more or all of the substations 221-222, 231, 241 can include multiple station levels. For example, some or all substations can include a lower station level 502 and at least one upper station level 504 that is vertically separated from positioned vertically above the lower station level 502. The levels 502, 504, in some implementations, correspond to two of the levels 108 of the storage structure 104. In some embodiments, each level 502, 504 of the substation can be cooperated with a respective transit deck 306-307. In some embodiments, a lower station level 502 of a respective substation 221-222, 231, 241, can be an entry level where robots 110 move in from a lower entry transit deck 306. The substation can include one or more substation vertical channels 501 forming part of a transit path of the mobile robots through a substation. The one or more substation vertical channels 501 can include one or more teeth, gearing, chains, other such structures and/or a combination of two or more of such structures that can be engaged by the mobile robots. In some embodiments, the substation vertical channels 501 can be similar to the vertical tower channels of the storage structure. The robots 110 can move into the substation at the lower station level 502, engage one or more of substation vertical channels 501, and self-propel themselves from the lower station level 502 to the upper station level 504. The substation vertical channel 501, in some embodiments, vertically aligns with the access port 310 and is configured to enable the robots 110 to self-propel vertically and move the respective containers 302 into position aligned within the access port 310.

Further, in some embodiments, one or more of the vertical channels 501 can include one or more charge rails to allow mobile robot to charge while climbing and/or cooperated with the vertical channels (e.g., positioned with the container aligned at the access port and awaiting interaction, such as from a picker). Additionally or alternatively, one or more charge rails can be positioned adjacent to one or move of the vertical channels enabling the mobile robots to contact and recharge an internal power source of the mobile robot 110. One or more of the substations 221-222, 231, 241 can include and/or cooperate with one or more guide tracks 320, links, rails, other such structures or a combination of two or more of such structures that can help to provide alignment for the mobile robots and/or provide a bridge between a transit deck and the substation vertical channel and/or an interior track of the substation. One or more lower guide tracks can be aligned with and couple with, for example, the entry transit deck 306 establishing part of the lateral transit path through the respective substation, and one or more upper guide tracks can be aligned with and couple with an exit transit deck 307. In some embodiments, the transit decks 306, 307 comprise planar surfaces upon which the robots 110 travel. The transit decks can have substantially any size that enable at least one mobile robot to travel upon the deck, and some of the transmit decks may be sized to at least enable the mobile robots to rotate and orient the respective robot and/or container 302, such as orient the robot and/or container consistent with an orientation of the substation and/or access port 310.

In some embodiments, the substation can further comprises an upper exit transit deck 307 positioned along the transit path proximate to the access port 310 and can be cooperated with the storage structure. The mobile robots 110, in some embodiments, exit the substation and move onto the exit transit deck 307, and can rotate upon the exit transit deck to orient the mobile robot 110 with a track of the storage structure, a vertical tower channels of the storage structure and/or other component of the storage structure, travel to and/or align with another substation cooperated with the transit deck, other such movements or a combination of two or more of such movements. The one or more transit decks 306, 307 can comprise one or more transit decks that can cooperate between the storage structure 104 and one or more workstation 106-107. In some embodiments, multiple different transit decks are cooperated with a single workstation, while in other implementations, a single transit deck may cooperate with and extend between two or more of the substations. Still further, in some embodiments, a transit deck 306 may extend between two or more workstations 106, 107.

The transit decks 306, 307 can comprise a planar surface upon which the mobile robots can move in substantially any horizontal direction through the control of one or more steering mechanism, which may include the variable control between two or more of the wheels of the mobile robot. The mobile robots 110 can use the transit decks in part to transport the containers, which can establish a planar route between the storage structure and the respective workstation. In some embodiments, a workstation 106 can cooperate with and/or include a transit deck that comprises a first section cooperated between the storage structure and at least one substation of the first set 220 of one or more substations, a second section cooperated between the storage structure 104 and one or more substations of the second set 230 of one or more substations, and a third section cooperated between the storage structure and one or more substations of the third set of one or more substations. In some embodiments, one or more of the transit decks extend between the two or more workstations, and/or one or more of the first section, the second section, and the third section of a transit deck can be coupled together.

One or more of the transit decks 306-307 can be sized to enable the mobile robots 110 to rotate, for example, to align with an intended direction of travel, such as direction into the substation, to a track of the storage structure 104 and/or other such orientation. In moving into a substation, the mobile robots 110 can moved from a track of the storage structure 104 and onto a transit deck 306, and when not appropriately aligned with a substation can move and/or rotate to orient the mobile robot, and a container 302 when being transported by the robot, to be consistent with an orientation of substation and/or the respective access port 310 of the substation, and enable access to the interior of the container through the access port 310. Some or all of one or more transit decks may extend through a portion of the storage structure 104. In some embodiments, one or more workstations 106, 107 can at least partially be embedded into the storage structure 104 such that one or more transit decks cooperated with those workstations extend at least partially within the storage structure at a first level of the levels 108 of the storage structure, and aligns with one or more of the aisles 109 of that first level. Similarly a second or upper transit deck 307 can be vertically separated from the first or lower transit deck 306. The lower transit deck 306 can be positioned at a lower station level 502, sometimes referred to as an entry station level for some embodiments, and cooperated between a first level 108 of the storage structure 104 and the entry station level. A second or upper transit deck 307 can be positioned at the upper station level 504 of the substation and cooperated between a second level of the storage structure 104 and the upper station level 504. The access port 310 of at least some of the substations is positioned at the upper station level 504.

In some embodiments, the mobile robots 110 can move into position relative to the substation and position the container 302 to at least partially align with the access port 310. Further, in some implementations, the container 302 is maintained on the mobile robot 110 as the mobile robot moves through the substation. As illustrated in FIGS. 5 and 6, in some embodiments, a mobile robot 110 may move (arrow 520) from a lower transit deck 306 and into an entry lower station level 502 of a substation, such as along a guide track 320a or the like. The mobile robot 110 may be transporting a container 302. The mobile robot 110 can engage a substation vertical channel 501, and move (arrow 521) from the lower station level 502 to the upper station level 504 and position a respective one of the containers 302 to at least partially align with the respective access port 310 while the respective one of the containers 302 remains on the mobile robot as the respective mobile robot moves through the substation. The mobile robot can maintain a position in the substation upper station level 504 while the container is intended to be accessible through the access port to enable products to be retrieved from and/or inserted into the container. When use of the container is complete, the mobile robot 110 can move (arrow 522) along out of the substation upper station level 504 along an upper guide track 320b and onto an exit transit deck 307. In other embodiments, a mobile robot may release the container into a position to align with the access port, and/or the substation may include a positioning system that positions the container to align with the access port.

In some embodiments, one or more or all of the workstations 106-107 can include one or more user interface systems that can include, but are not limited to one or more displays 262 and/or touch screens, one or more user input interfaces 264 (e.g., keyboard, mouse, touchpad, buttons, other such input interfaces, or a combination of two or more of such input interfaces), cameras 266, sensors, lighting systems 268 and/or laser pointer systems, audio systems, other such user interface systems, or a combination of such systems. The user interface systems may be similar to those described above and/or described in U.S. Pat. Nos. 9,139,363, 10,435,241, and 11,142,398, and U.S. Patent Application Publication Nos. 2019/0270591, and 2021/0229271, each of which is incorporated herein by reference in its entirety.

The substations of workstations 106-107 can be positioned to establish an access area 202 adjacent the substations with the substations positioned such that each access port 310 of the workstation 106-107 is accessible by a picker from the access area 202. In some embodiments, the access area 202 is defined by boundaries of the sets of substations of a workstation 106-107. For example, when the workstation 106 includes three sets 220, 230, 240 of substations, the access area can be defined by the boundaries of the first, second and third sets of substations. Similarly, when the workstation only includes first and second sets of substations, the access area can be defined by the both the first and second sets of substations. In some embodiments, the access area 202 is defined between the first, second and third sets 220, 230, 240 of one or more substations. Because of the positioning of the multiple substations of a workstation, the access area provides at least one and typically two or more pickers to readily access the containers 302 when positioned aligned with an access port 310 of a respective substation. Further the access area, in some embodiments, is established providing ease of movement within the access area between substations improving access to containers through the access ports 310, which provides improved efficiency in the transfer of products into, out of and/or between containers moved into alignment with the multiple different access ports 310 of a single workstation. Additionally, some embodiments enhance the access to the access ports through the angled orientation of one or more sets of substations. For example, the second set 230 and third set 240 of one or more substations can be rotated to be at respective angles 212, 213 relative to the orientation of the first set 220 of substations and/or the storage structure, which provides enhanced access.

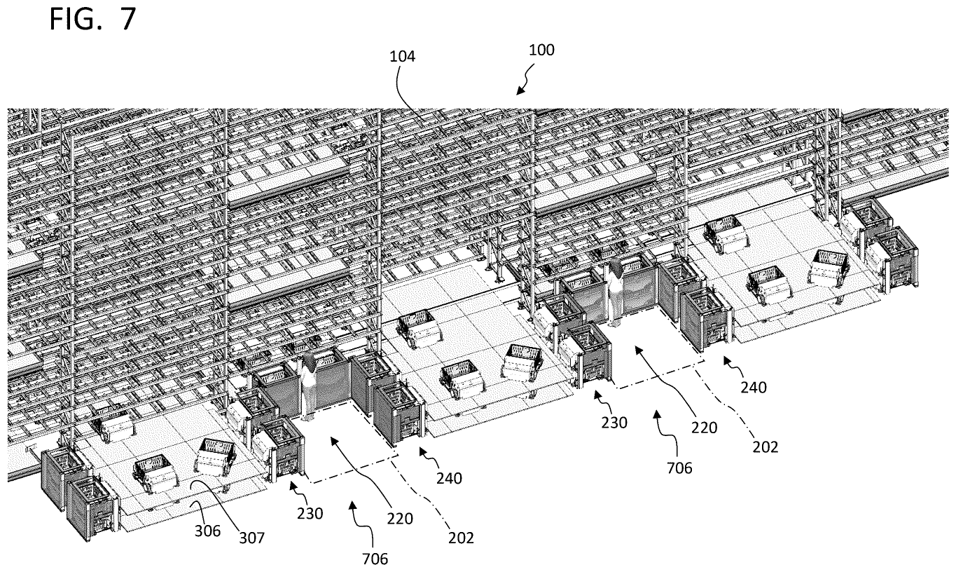

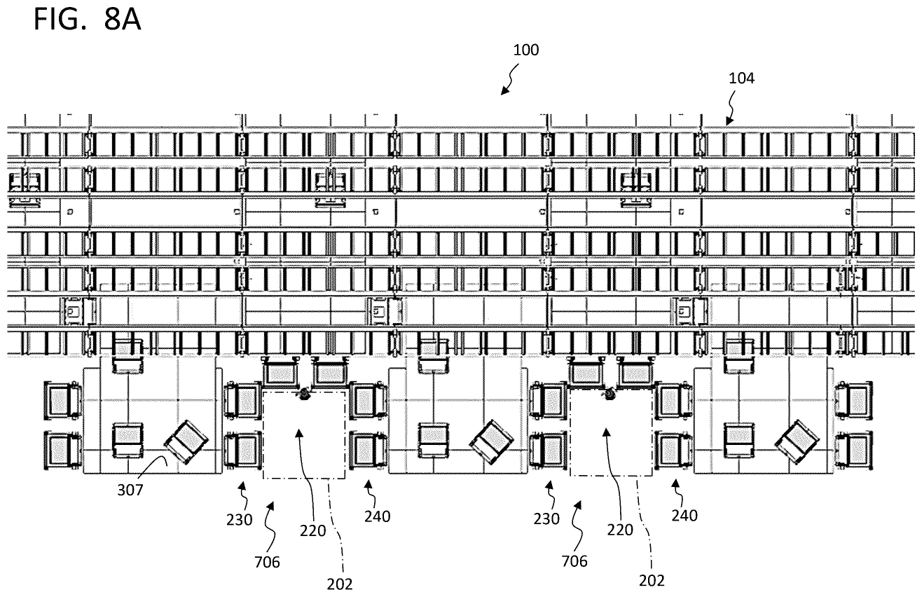

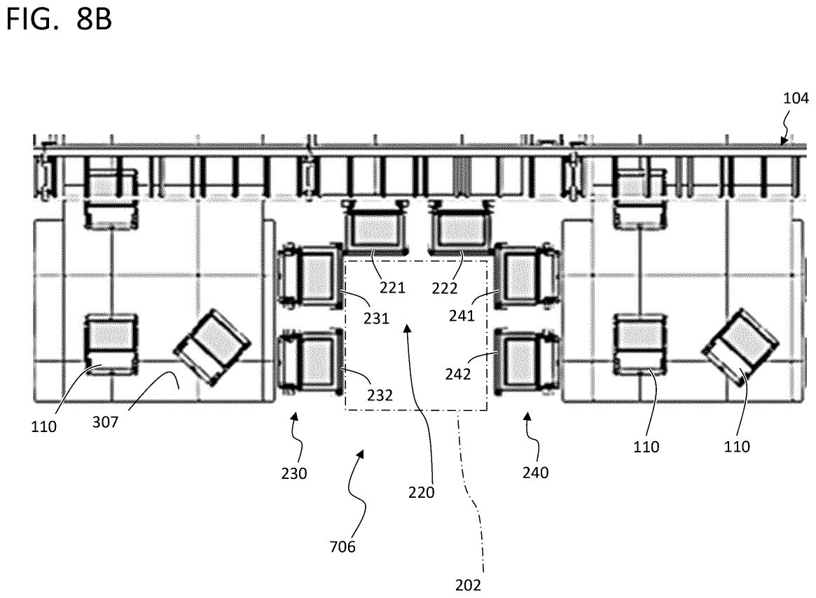

FIG. 7 illustrates a illustrates a perspective view of example workstations 706 of a container storage and retrieval system 100 that are positioned external to the storage structure 104 and spaced along an exterior of the storage structure, in accordance with some embodiments. FIG. 8A illustrates a block diagram, overhead view of example workstations 706 of FIG. 7 cooperated with a storage structure 104, in accordance with some embodiments. FIG. 8B illustrates a block diagram, zoomed in view of an example workstation 706 of FIG. 7, in accordance with some embodiments. A first set 220 of one or more substations can be positioned at or beyond an exterior boundary and outside of the storage structure 104, with second 230 and third sets 240 of one or more substations oriented perpendicular to the exterior side of the storage structure, and further oriented mirrored to each other establishing the access area 202. Further, some embodiments the second set 230 includes two or more substations 231, 232, and/or the third set 240 can include two or more substations 241, 242 adjacent substations extending away from the storage structure. The access area 202 is formed and/or defined in some embodiments by access sides of the respective substations, and the two-dimensional area defined between the substations of the first set 220, second set 230 and when present the third set 240 of one or more substations. The orientation of the access sides of the substations of the second set 230 of substations can face the access sides of the substations of the third set 240 of substations. From the access area 202, one or more pickers can readily access any of the access ports 310 of the substations of a workstation 706. One or more transit decks 306, 307 can extend at least partially outside of the storage structure between the storage structure 104 and one or more of the workstations.

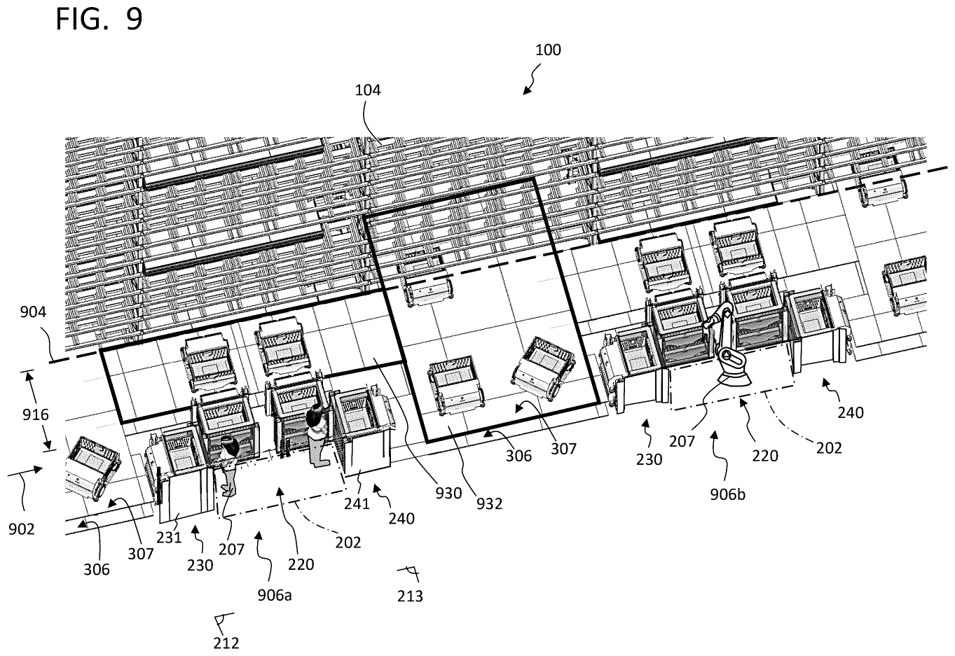

FIG. 9 illustrates an overhead, perspective view of example workstations 906 of a container storage and retrieval system 100 that are positioned external to the storage structure 104, in accordance with some embodiments. In some embodiments, the workstations 906 and/or one or more sets of one or more substations can be exterior to an exterior boundary 904 of and outside of the storage structure 104, and in some embodiments can be separated from the exterior boundary 904 of the storage structure 104 by a distance 916. The first set 220 of substations 221, 222 of one or more of the workstations 906 can be oriented with an access sides aligned along a first axis 902, which in some instances can be substantially parallel an axis of the exterior dimension of the storage structure (e.g., axis 116 illustrated in FIG. 1A). One or more substations 231 of a second set 230 of substations can be positioned and oriented at a first angle 212 to the first axis 902, and one or more substations 241 of a third set 240 of substations can be positioned and oriented at a second angle 213 to the first axis 902. The second angle, in some embodiments, is a mirror angle to the first angle. An access area 202 is defined by boundaries of the first, second and third sets of substations, with the substations positioned such that each access port of the more substations are accessible by one or more pickers (e.g., people, robots, etc.) from the access area 202. The one or more substations of the second set 230 of substations and the third set 240 of substitutions can be positioned offset (e.g., further from the storage structure) from the one or more substations of the first set 220 of substations establishing larger access area 202.

In some embodiments, one or more transit decks 306, 307 can extend between the storage structure 104 and one or more of the workstations 906 and/or the sets 220, 230, 240 of one or more substations. In some implementations, for example, a first section 930 of a first transit deck 307 is cooperated between the first set 220 of one or more substations of a first workstation 906a and the storage structure 104, and can extend along a first axis 116 of the storage structure and along a portion of an exterior of the storage structure. In some embodiments, the first section 930 may further extend into the storage structure establishing a planar path with one or more tracks along one or more aisles of the storage structure and/or with one or more vertical channels of the storage structure. Some embodiments may include one or more second sections 932 of the transit deck that can cooperate with the first section 930 of the transit deck and extend between the third set 240 of one or more substations of the first workstation 906a and a second set 230 of one or more substations of a second workstation 906b.

The embodiments illustrated in FIG. 9 shows an example sections of transit decks providing continuous transit decks extending from the storage structure to multiple workstations 906. In other embodiments, however, separate transit decks and/or sections of transit decks may be used between individual workstations and/or sets of substations. Further, in some embodiments, the substitutions of the workstations 906a-906b can be multi-level substations, similar to those described above, and pairs of transit decks (e.g., enter or lower transit deck 306, and exit or upper transit deck 307) can cooperate between the storage structure 104 and one or more of the workstations 906a, 906b and/or one or more sets of substations. Mobile robots 110 can transition between the storage structure and the workstations 906a, 906b via the transit decks. In some embodiments, mobile robots 110 can transition between two or more workstations via the transit decks.

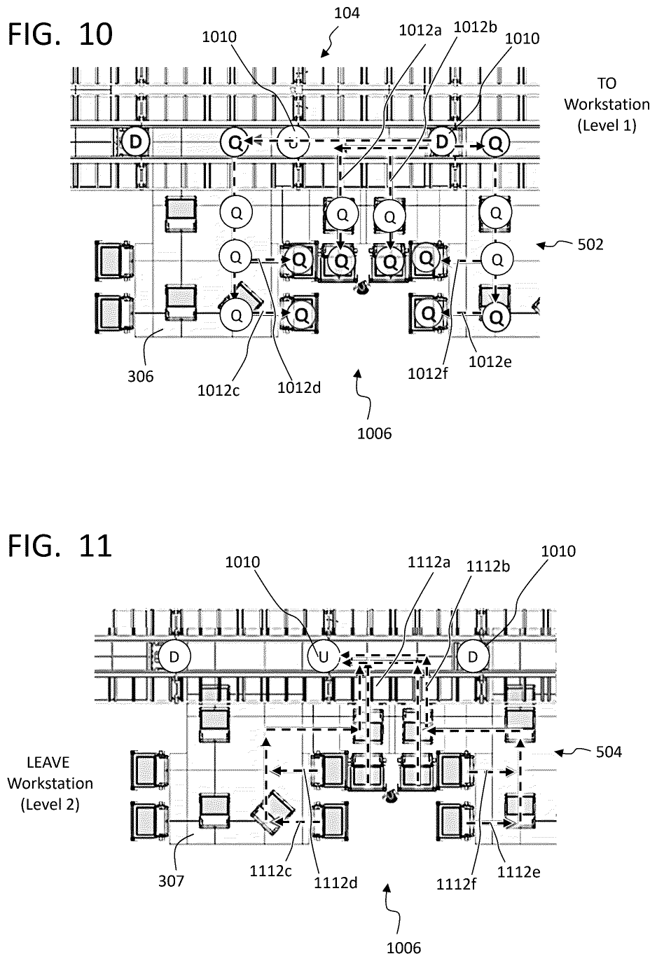

FIG. 10 illustrates an overhead view of a lower station level 502 of a workstation 1006 cooperated with a storage structure 104 of a container storage and retrieval system 100, in accordance with some embodiments. One or more vertical channels 1010 can be used by the mobile robots to move from levels of the storage structure to the entry level (e.g., lower station level 502) of the workstation 1006. The workstations can cooperate with the storage structure 104 to provide queuing of the mobile robots transporting containers. In some implementations, one or more mobile robots 110 can move down a “down” vertical channel 1010 and follow one of multiple paths through the storage structure, along one or more transit decks 306 and to access one of the sets of substations of the workstation 1006. FIG. 10 shows with dashed lines multiple example paths 1012a-1012f in accordance with some embodiments. The mobile robots can be queued (“Q”) within the storage structure and/or along the various paths to the intended substation and/or access port.

FIG. 11 illustrates an overhead view of an upper station level 504 of the workstation 1006 of FIG. 10, in accordance with some embodiments. Further illustrated are example exit paths 1112a-1112f each from one of the substations of the sets of one or more substations. The exit paths can provide paths, for example, along the transit deck 307 back into the storage structure, such as to access one of the vertical channels 1010 (e.g., to move to an upper level of the storage structure). One or more vertical channels 1010 can be used by the mobile robots to move from levels of the storage structure to the entry level (e.g., lower station level 502) of the workstation 1006. The workstations can cooperate with the storage structure 104 to provide queuing of the mobile robots transporting containers. In some implementations, one or more mobile robots 110 can move down a “down” vertical channel 1010 and follow one of multiple paths to access one of the sets of substations of the workstation 1006. FIG. 10 shows with dashed lines multiple example paths 1012a-1012f in accordance with some embodiments. The mobile robots can be queued (“Q”) within the storage structure and/or along the various paths to the intended substation and/or access port

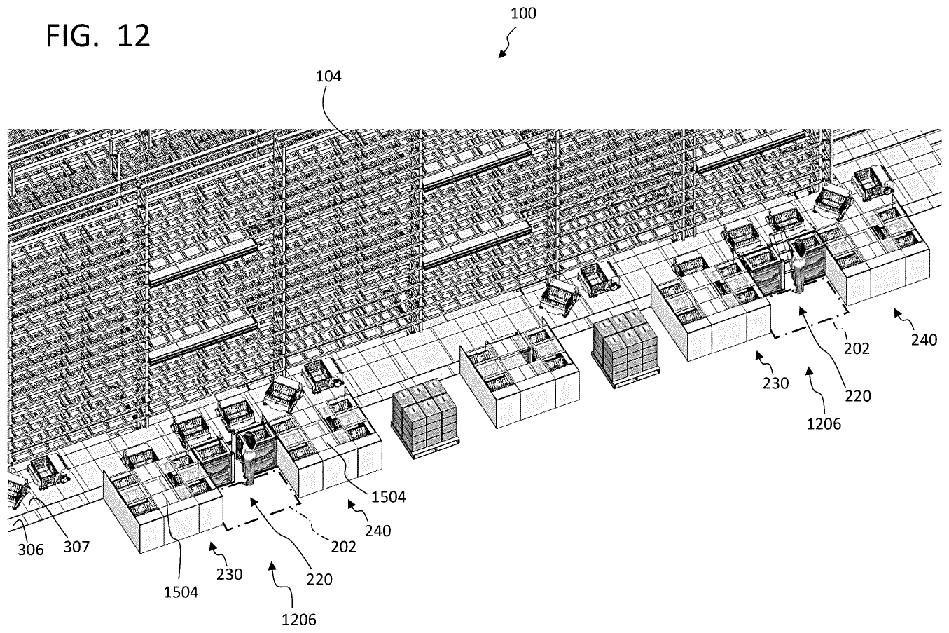

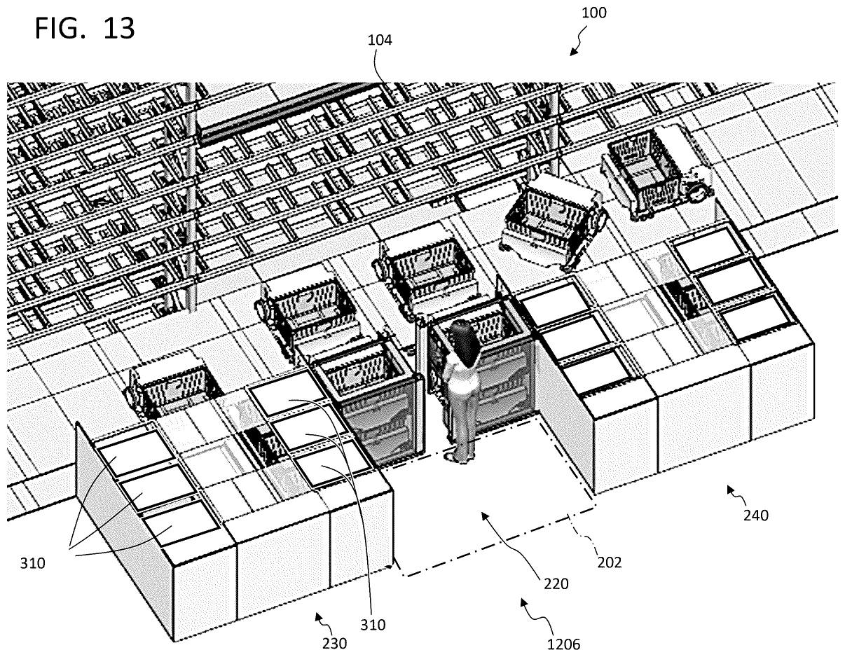

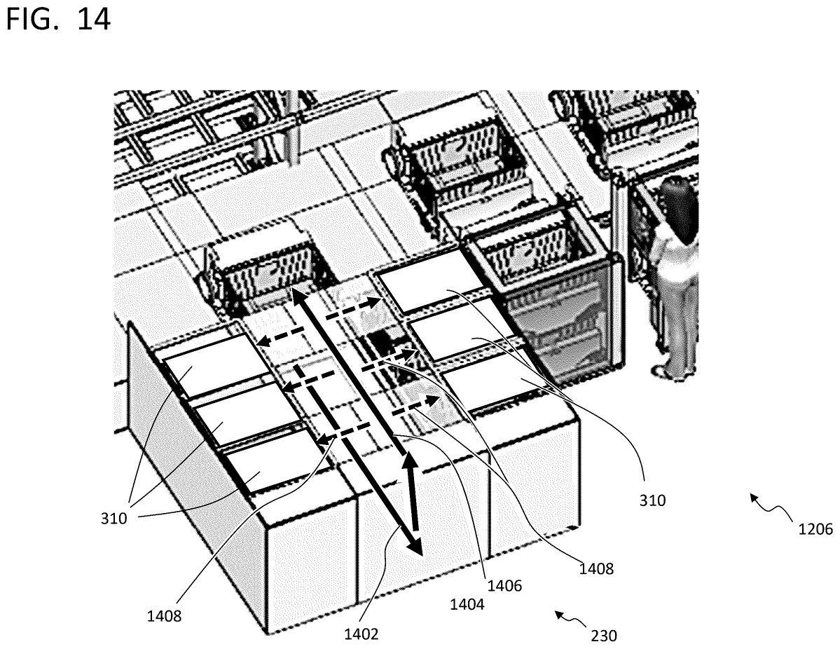

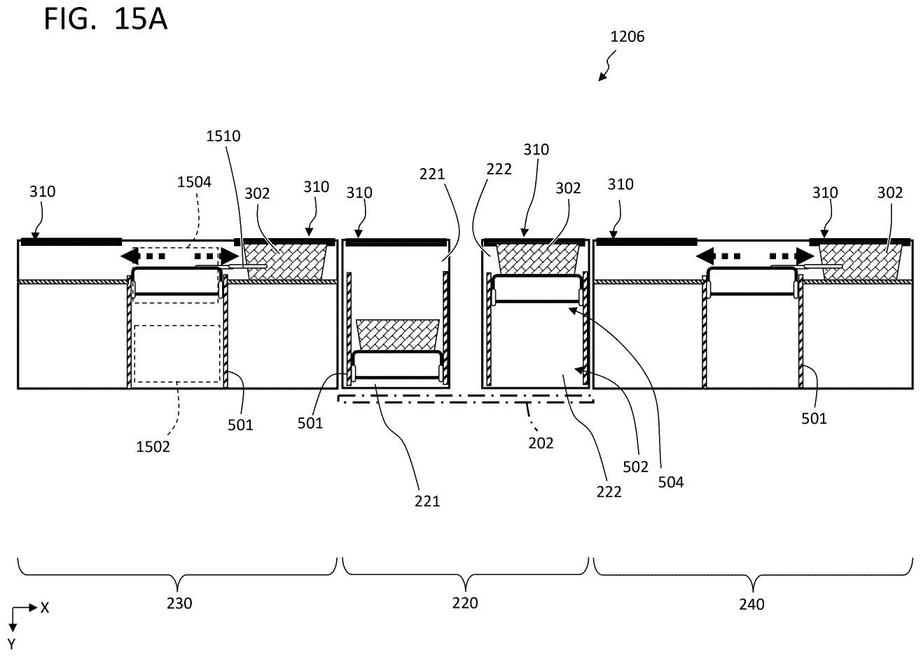

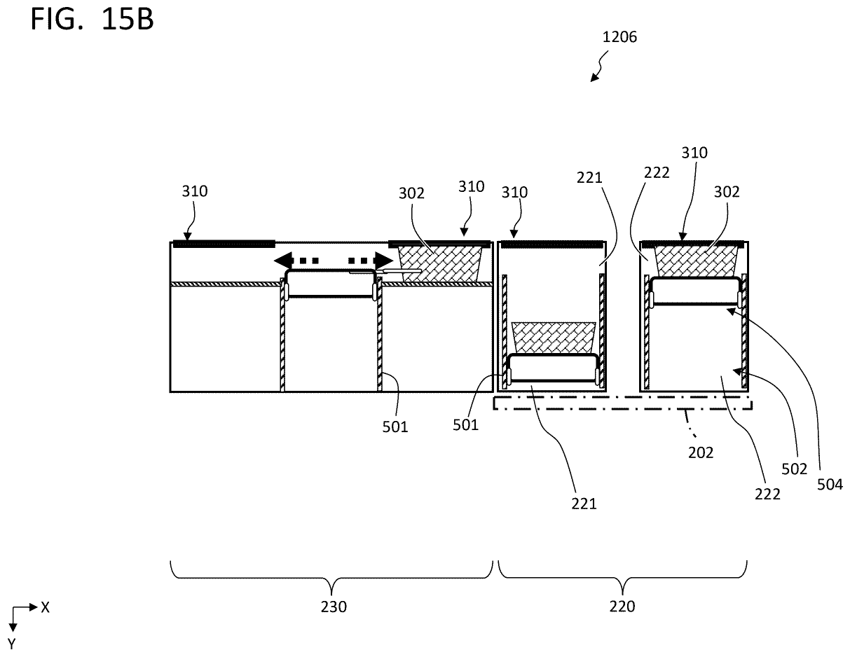

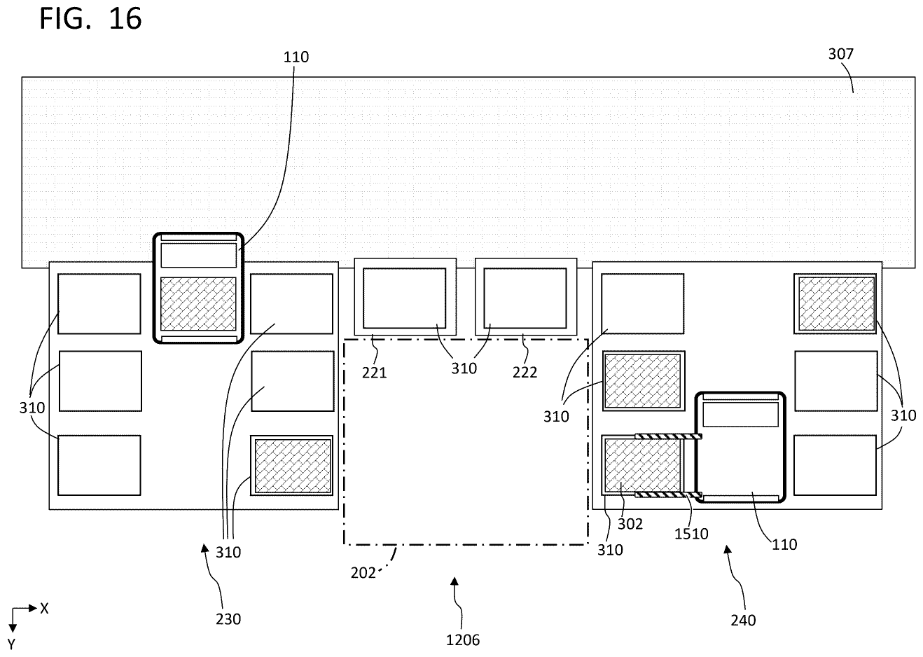

FIG. 12 illustrates an overhead, perspective view of example workstations 1206, of a container storage and retrieval system 100, that are positioned external to the storage structure 104, in accordance with some embodiments. FIG. 13 illustrates an overhead, perspective view of an example workstation 1206 of FIG. 12, positioned external to the storage structure 104, in accordance with some embodiments. FIG. 14 illustrates an overhead, perspective view of a portion of an example workstation 1206 of FIG. 12, in accordance with some embodiments. FIG. 15A illustrates a block diagram plane view of an example workstation 1206 of FIG. 12, with a first set 220 of one or more of substations 221, 222, a second set 230 of one or more substations with multiple access ports 310, and a third set 240 of one or more substations with multiple access ports 310, in accordance with some embodiments. FIG. 15B illustrates a block diagram plane view of an example workstation 1206 of FIG. 12, with a first set 220 of one or more of substations 221, 222, and a second set 230 of one or more substations with multiple access ports 310, in accordance with some embodiments. FIG. 16 illustrates a block diagram overhead plane view of an example workstation 1206 of FIG. 12, in accordance with some embodiments. Referring to at least FIGS. 12-16, the workstations 1206 can include at least two sets 220, 230 of one or more substations, and in some embodiments three sets 220, 230, 240 of one or more substations. The second and third sets 230 and 240 can be positioned on either side of the first set 220 of substations and extend away from the access side of the first set of substations establishing the access area 202. In some embodiments, the access area 202 is defined by boundaries of the sets of one or more substations, with access ports of each of the sets of one or more substations being positioned along sides of the access area and readily accessible by one or more pickers from the access area.

In some embodiments, each substation 221, 222 of the first set 220 of one or more substations includes one or more access ports 310 positioned relative to a first side of the access area (e.g., extending parallel with a side of the storage structure 104), and that enable access to a container when positioned at least partially aligned with a respective one of the access ports. In some embodiments, the first set 220 of one or more substations 221, 222 are similar to the first set 220 of one or more substations described above (e.g., described in reference to FIGS. 2A-2C). The second set 230 and/or third set 240 of one or more substations, in some embodiments, can include one or more sets of one or more and typically multiple access ports 310 that are spaced along a length of the respective first and second set 230, 240 of one or more substations. A first set of access ports 310 can be positioned along second and third sides of the access area 202.

Further, in some embodiments, the second and third sets 230, 240 of one or more substations can include a first station aisle 1502 at a first or lower station level 502 and a second station aisle 1504 at a second or upper station level 504 (or multiple upper station aisles vertically aligned). The first station aisle 1502 is configured to enable the mobile robots 110 to self-propel and travel along the lower station level, and second station aisle 1504 is configured to enable the mobile robots 110 to travel along the upper station level. In some embodiments, the lower station aisle 1502 is typically utilized as an entry level where the mobile robots enter the second set 230 or third set 240 of one or more substations to move along (arrow 1402, of FIG. 14) the second set or third set of one or more substations, and can engage one or more station vertical channels 501 and self-propel to the upper station level 504 (arrow 1404). The mobile robot can then use the upper station aisle 1504 to self-propel and move along (arrow 1406) one or more sets of access ports 310 positioned along a length of the second set 230 of one or more substations to align with an intended one of the access ports 310 to move a container 302 into at least partial alignment with a corresponding access port 310 and/or retrieve a container 302 that is positioned in at least partial alignment with an access port. In some embodiments, the second set and/or third set of one or more substations can include a set of one or more access ports on both sides of the upper station aisle 1504. One or both of the lower station aisle 1502 and upper station aisle 1504 can be used, in some implementations, as part of a queue of one or more mobile robots 110 entering and/or exiting the respective set of one or more substations. Similarly, the lower and upper transit decks 306, 307 cooperate with the lower and upper aisles 1502, 1504, respectively, which may additionally or alternatively be utilized in queuing mobile robots 110 and/or containers 302 relative to one or more workstations. In some embodiments, two workstations 1206 may be adjacent, and one of the sets of one or more substations (e.g., the third set 240) can be utilized by both of the neighboring workstations. Still further, some embodiments additionally or alternatively utilize portions of the storage structure as part of a queuing scheme to position containers and/or mobile robots transporting containers into a position in preparation for use at a workstation.

In some embodiments, the second set 230 and/or third set 240 of one or more substations can include a first set of access ports 310 positioned along at least a first portion of the respective second station aisle, proximate the access area along an access side of the respective second set 230 and third set 240 of one or more substations and are accessible by the mobile robots while the mobile robots are positioned on the second station aisle. In some embodiments, the third set 240 of one or more substations can be part of a neighboring second workstation, and can comprise a second set of access ports positioned along at least a portion of the upper station aisle 1504, and these second set of access ports can be accessible by the mobile robots while the mobile robots are positioned on the upper station aisle 1504. As such, while a mobile robot is positioned on the upper station aisle 1504, the mobile robot can interact with either set of access ports 310 on each side of the upper access aisle. For example, the upper station aisle can be configured to enable the mobile robots to align with any one of a first set of access ports on a first side of the upper station aisle and/or any one of a second set of access ports on a second side of the upper station aisle and to move a container align with one of the access ports of either the first set of access ports or the second set of access ports as instructed.

In some embodiments, one or more or each of the access ports 310 of the first and/or second set of access ports, of the second set 230 and/or third set 240 of one or more substations, can be configured to receive (arrow 1408) a respective one of the containers 302 moved into the respective access port and released by a respective one of the mobile robots 110 such that the container does not remain on the mobile robot while the container is accessible through the access port. Similarly, in some embodiments, a mobile robot on the station aisle can retrieve a container 302 positioned at an access port on either side of the station aisle. One or more mobile robots can travel along the second station aisle and align with any one of the access ports 310 of the one or more sets of access ports and to move container to align with an access port of one of the set of access ports. Further, in some embodiments, the second set 230 and/or third set 240 of one or more substations are configured so that the containers 302 are dropped off by the robot and left at the substation enabling the mobile robot to move away from the access port and/or move out of the respective set of one or more substations, while the container remains at the substation. The container can remain in the substation for substantially any duration of time and can subsequently be retrieved by the a different or the same mobile robot at a later time. Further, a mobile robot moving along the upper station aisle 1504 can deposit a first container to be in at least partial alignment with a first access port, and retrieve a second container that is in the same set of one or more substations and aligned with a different one of the access ports. The mobile robots, for example, can include a container transport system 1510 that can pull containers onto the mobile robot and push containers off of the mobile robots, and this container transport system can be used to move containers into alignment with an access port and leave the container, and/or retrieve containers that are awaiting retrieval from another access port. The container transport systems can be the same as or similar to those described in U.S. Pat. Nos. 9,139,363, 10,435,241, and 11,142,398, U.S. Publication No. 2023/0095494, and U.S. Provisional Application No. 63/626,967, each of which is hereby incorporated by reference in its entirety. In some embodiments, one or more safety doors, covers or the like may be included and/or cooperated to cover one or more the access port 310.

In some embodiments, the first set 220, second set 230 and/or third set 240 of one or more substations can be partially embedded within the storage structure 104. In other embodiments, the first set, second set and third set are external to the storage structure, and one or more of the workstations 1206 can be spaced along a dimension (e.g., a length) of the storage structure 104. Additionally or alternatively, one or more of the workstations 1206 can be positioned spaced from the storage structure 104, and in some embodiments one or more transit decks 306, 307 extend between the storage structure 104 and one or more of the workstations and/or one or more of the sets of one or more substations of a workstation. FIG. 12 shows continuous lower transit deck 306 and upper transit deck 307. It will be appreciated, however, that a continuous deck does not have to be included, and instead multiple transit decks can be provided to establish the transit paths between the storage structure and one or more of the workstations. As described above, the workstations 1206 can be utilized for dispense, decant, order assembly, consolidation and/or other such applications within the storage and retrieval system 100, which can include enable picking with product containers presented and products retrieved from product containers in fulfilling orders (e.g., placing picked products into bags, order containers, etc.), and/or other operations.

In some embodiments, one or more of the access ports 310 can be on the access side of the sets of substations, and in some implementations, one or more of the access ports can comprise access drawers that can be opened from the access side of the substations enabling access into the container within the access drawer, and/or enable a container to be removed from and/or inserted into the access drawer and subsequently retrieved by a mobile robot (e.g., in decanting and ingesting products into the storage and retrieval system 100). Similarly, one or more access drawers may be positioned along the lower station aisle 1502, further increasing throughput out of and/or into the storage and retrieval system 100.

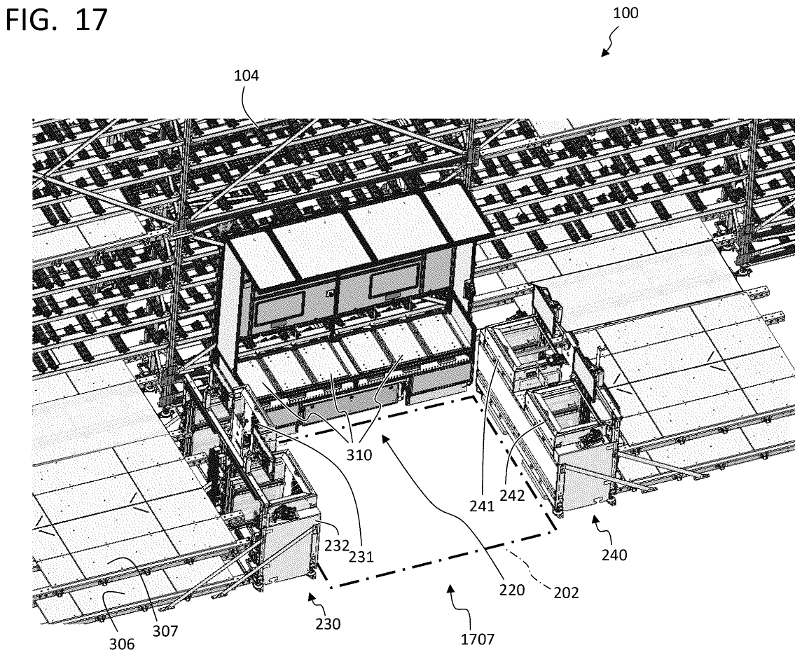

FIG. 17 illustrates an overhead perspective view of an example workstation 1707 of an example container storage and retrieval system 100, in accordance with some embodiments. The workstation 1707 cooperates with a storage structure 104 of the container storage and retrieval system 100. The workstation can include two or more sets of substations. In the illustrated embodiments the workstation 1707 can include a first set 220 of one or more substations and/or access ports 310, a second set 230 of one or more substations 231, 232, and a third set 240 of one or more substations 241, 242. While the workstation 1707 is shown external to and abutting the storage structure, in other embodiments some or all of the first set 220 of one or more substations and/or access ports 310 may be positioned partially or fully embedded within the storage structure. One or more pairs of transit decks 306, 307 may cooperate with one or more of the sets 220, 230, 240 of one or more substations to provide a transit path for the mobile robots between the storage structure 104 and the workstation 1707. In some embodiments, the first set 220 of one or more substations comprises a static substation with multiple access ports 310. Mobile robots approach the first set of one or more substations and leaves a container and/or retrieves a container from one of the access bays. The static substation may be similar to one or more stations described in U.S. Patent Application Publication Nos. 2016/0355337, 2017/0313514, 2018/0134492, 2020/0223630, 2022/0194704, 2023/0053089, which are incorporated herein by reference in their entirety.

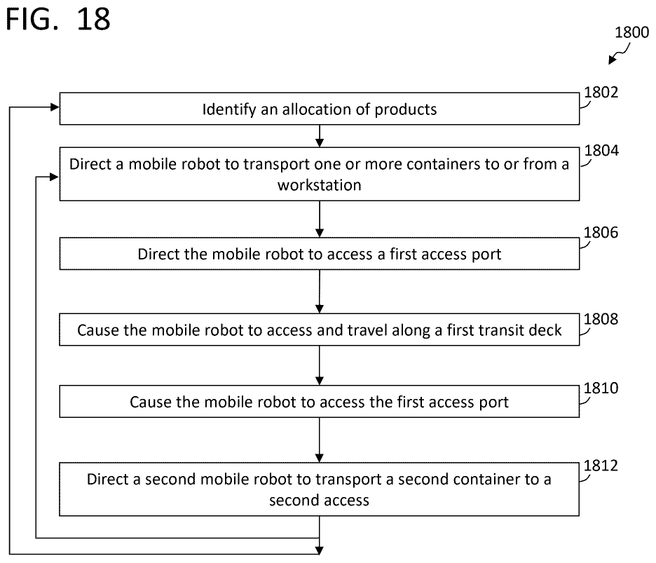

FIG. 18 illustrates a flow diagram of an example process 1800 of controlling inventory and fulfilling orders, in accordance with some embodiments. In step 1802 an allocation of one or more products is identified. This allocation can be based on one or more orders for one or more products, inventory consolidation, inventory decanting, inventory movement, inventory disposal and/or other inventory control. Typically, the products are within a storage structure 104 and/or to be moved into the storage structure of a storage and retrieval system 100 that comprises workstations 106, 107 that can be spaced at different locations along the storage structure, and multiple vertically spaced levels 108 that each comprise multiple aisles 109. The aisles can comprise storage locations 105 that are configured to store at least one container 302. In step 1804, one or more mobile robots are each directed to transport one or more containers 302 through the storage structure 104 to or from one or more workstations 106, 107 cooperated with the storage structure and accessible by the mobile robots. In some embodiments, a workstation 106 can be at least partially embedded into the storage structure 104 such that a first transit deck extends at least partially within the storage structure at a first level, of the multiple levels, and aligned with one or more of the aisles of the first level. In step 1806, the mobile robot is directed to transport a container to an access port of a first workstation 106, 107 of the storage and retrieval system 100.

In step 1808, a mobile robot can be directed to access and travel along a first transit deck, which comprises a planar surface and can be cooperated between the storage structure and one or more workstation 106, 107. In some embodiments, directing the mobile robot to access the access port can cause the mobile robot to travel along the first transit deck beyond an exterior boundary of and outside of the storage structure where the first transit deck extends at least partially outside of the storage structure between the storage structure and the first workstation. In step 1810, the mobile robot can be directed to access the first access port 310 of one of a first set 220 of one or more substations positioned in a first orientation that is substantially parallel with a first axis 116 of the storage structure 104 and a second set of one or more substations (e.g., second set 230) positioned in a second orientation that is different than the first orientation along a second axis 217 that is at a first angle to the first axis of the storage structure. The first and second sets of one or more substations can define an access area 202, which is typically bounded by both of the first set 220 of one or more substations and the second set 230 of one or more substations, with the first and second sets of one or more substations positioned such that each access port of the first and second sets of one or more substations are accessible by a picker from the access area, wherein each substation of the first and second sets of one or more substations comprises a respective access port that is accessible by the mobile robots and configured to enable a respective container 302, of the containers, to be exposed through each of the respective access ports allowing a product to be inserted and/or removed by the picker.

In step 1812, a second mobile robot can be directed to transport a second container 302 from the first set 220 of one or more substations of the first workstation 106, 107 to a second access port 310 of a second set of one or more substations of different workstation or a different set of substations, and/or a storage location 105 of the storage structure 104. This can cause the second mobile robot 110 to travel, for example, along a first section of a transit deck 307 that is cooperated between a first set of one or more substations and the storage structure 104 and extends along a first axis and along a portion of an exterior of the storage structure, move from the first section to the transit deck to a second section of the transit deck and access the second access port of the second set of one or more substations of the second workstation. In some embodiments, the first transit deck can extend between a third set of one or more substations of the first workstation and the second set of one or more substations of the second workstation. One or more of the steps may be repeated, and typically products are repeatedly allocated during operating hours of a facility.

In directing the first mobile robot to access the first access port, some embodiments direct the mobile robot to access the first access port of one of the second set of one or more substations and the third set of one or more substations that are positioned within the storage structure. Additionally or alternatively, in some embodiments the directions can cause the mobile robot to travel along at least one of: a first section of the first transit deck cooperated between the storage structure and the first set of one or more substations; a second section of the first transit deck cooperated between the storage structure and the second set of one or more substations; and a third section of the first transit deck cooperated between the storage structure and the third set of one or more substations.

In some embodiments, one or more workstations can comprise third set 240 of one or more substations oriented opposite the second set 230 of one or more substations and along a third axis that is at a second angle to the first axis of the storage structure. The third set of one or more substations can comprises a third set of at least one access port accessible by the mobile robots and each configured to enable one of the containers to be exposed through the respective one of the third set of at least one access port allowing the products to be inserted and/or removed. The access area 202 can be defined between the first set 220 of one or more substations, the second set 230 of one or more substations and the third sets 240 of one or more substations with the first, second and third sets of one or more substations positioned such that each access port 310 of the first, second and third sets of one or more substations are accessible by the picker from the access area. Further, in some embodiments a control circuit can direct a second mobile robot to travel from a first workstation 106 to a second workstation 106 causing the second mobile robot to travel along one or more transit decks extending between the first workstation and the second workstation. This can avoid having to re-enter the storage structure which can cause congestion in the storage structure, increase delays, increase travel distance, and the like.

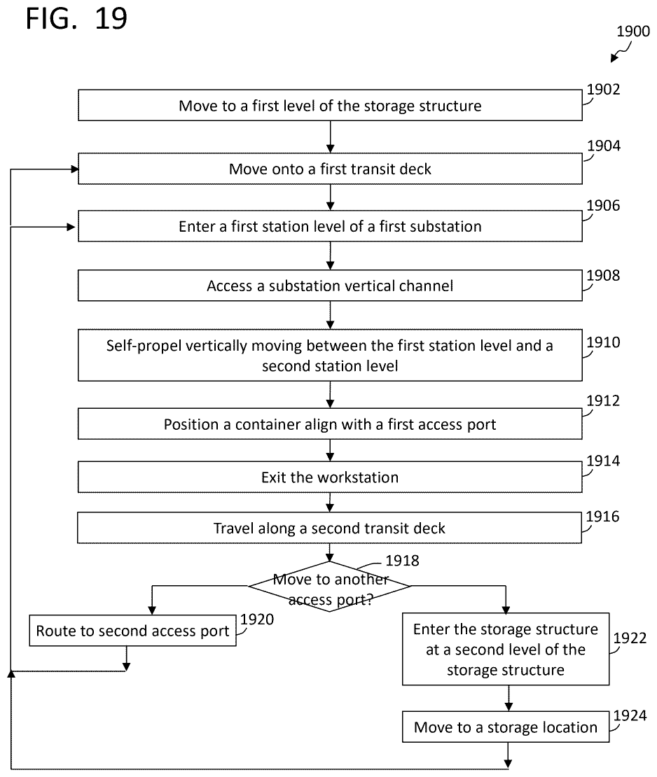

FIG. 19 illustrates a flow diagram of an example process 1900 of controlling inventory through the control of mobile robots in a storage and retrieval system 100, in accordance with some embodiments. In step 1902, a mobile robot autonomously controls itself to move through the storage structure 104 to a first level 108 of the storage structure. In step 1904, the mobile robot can travel from the first level and move onto a first transit deck 306, which may be is aligned with an entry station level of an intended substation of an intended workstation 106. In step 1906, the mobile robot can enter the entry station level 502 of the intended substation of a set of one or more substations of the intended workstation 106, which typically includes multiple sets of one or more substations. In some embodiments, the mobile robot while on the transit deck may rotate and/or steer itself to orient itself to move into the entry station level.

In step 1908, the mobile robot can advance along the entry station level 502 to engage one or more substation vertical channels 501 of the substation. In some embodiments, the substation includes two or more substation vertical channels that are engaged by the mobile robot to enable the mobile robot to self-propel vertically along the substation vertical track channel within the substation. The substation vertical channel 501 can extend between the entry station level 502 and one or more other station levels, which may be vertically higher or lower than the entry level, such as extending between the entry station level 502 and a second station level 504 (e.g., an exit station level) of the substation that is cooperated with an intended access port 310. The second station level 504 can be vertically separated from the first or entry station level. Accordingly, in step 1910, the mobile robot can self-propel vertically moving between the first station level and a second station level. In step 1912, the mobile robot can position a respective one of the containers being transported by the mobile robot to at least partially align with the intended access port 310 while the container remains on the mobile robot. In some embodiments, the access port 310 is aligned with the station vertical channel such that as the mobile robot elevates the container vertically moves into the access port. In other embodiments, in step 1912 the mobile robot moves the container off of the mobile robot to at least partially align with the access port. Further in some instances, the mobile robot can release the container 302 into the substation of an intended set of one or more substations such that the container at least partially or fully aligns with the intended access port 310 and does not remain on the mobile robot while the container is accessible through the access port. In step 1914, the mobile robot can move along the second or exit station level 504 and exits the set of substations. In step 1916, the mobile robot, in some embodiments, exits the set of substations onto and a second transit deck 307, which is vertically separated from the first transit deck 306, and can travel along the second transit deck toward a subsequent destination.

Some embodiments can include step 1918 where the mobile robot can determine whether it is instructed to advance to a different access port 310 of the same workstation or a different workstation. In some instances where the mobile robot is to proceed to a second access port, whether to transport a container to the second access port and/or retrieve a container, the process 1900 can advance to step 1920 where the mobile robot autonomously moves through the storage and retrieval system 100 to the intended second access port. In some embodiments, step 1920 returns the process 1900 to step 1904 and/or 1906 to route toward the intended workstation and the substation of that workstation. In some embodiments, when it is determined that the mobile robot is not directed to another access port, the process may optionally advance to step 1922, where the mobile robot can move along one or more transit decks and reenter the storage structure 104. For example, the mobile robot may travel from the upper transit deck 307 into a second level 108 of the storage structure 104, where the second level 108 of the storage structure is vertically separated from the first level of the storage structure. In step 1924, the mobile robot may move vertically and/or horizontally within the storage structure to an intended storage location to deposit a container being transported by the mobile robot into the storage location 105, and/or retrieve a container from the storage location. One or more steps of the process 1900 and/or the entire process can be repeated substantially any number of times.

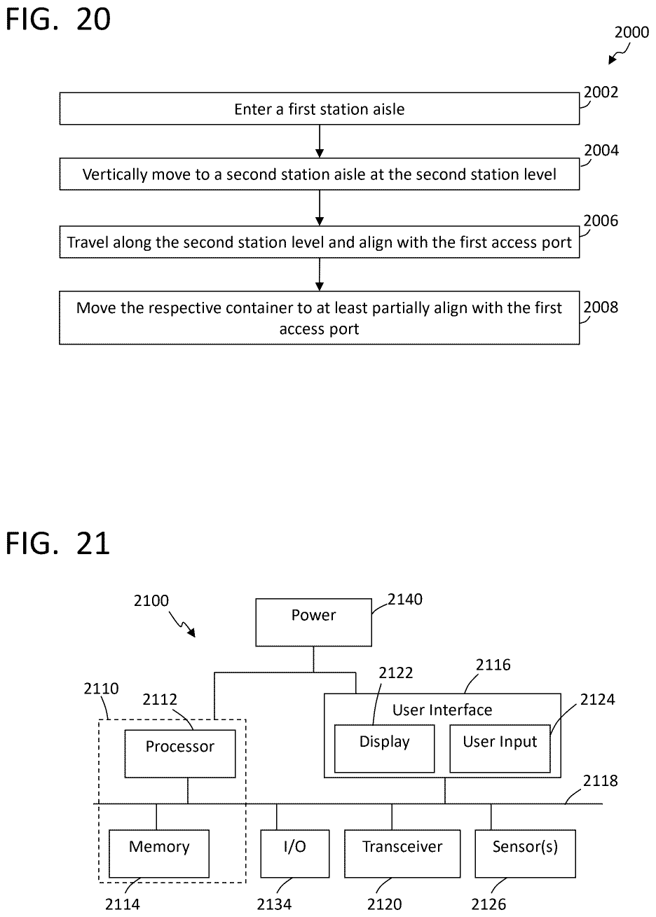

FIG. 20 illustrates a flow diagram of an example process 2000 of positioning a container within a substation (e.g., substation 231) of a workstation 106, in accordance with some embodiments. In step 2002, a mobile robot can enter a first station aisle 1502, of an intended set of one or more substations (e.g., second set 230). The first station aisle 1502 can be positioned at a first or entry station level 502. The robot upon entering can travel along the first station aisle 1502 and engage a substation vertical channel 501. In step 2004, the mobile robot can vertically move to a second station aisle 1504 at a different second station level 504. In step 2006, the mobile robot can travel along the second station aisle 1504 at the second level, and align with the an intended access port 310, of a first set of access ports that are positioned along at least a first portion of the second station aisle 504 and accessible by the mobile robots while the mobile robots are positioned on the second station aisle. In step 2008, the mobile robot can move the respective container 302 to at least partially align with the intended first access port 310.

The process 2000 can be repeated any number of times with the same and different mobile robots transporting the same and different containers in order to provide products within the containers to be accessible through the access port, to enable product to be inputted into containers through the access ports, to remove and/or input containers from and/or into the storage and retrieval system 100, and/or other such actions. In some embodiments, for example, a control circuit can direct a second mobile robot 110 to transport a second container 302 to a second access port 310 of a second set of access ports of a second workstation. The mobile robot, in response to the directions, can move to the second station aisle 1504 and travel along the second station aisle to the second access port 310, of the second set of access ports that are positioned along at least a second portion of the second station aisle and accessible by the second mobile robot while the second mobile robot is positioned on the second station aisle. The second mobile robot can position the second container to at least partially align with the second access port 310 of the second set of access ports of the second workstation enabling access through the second access port into the second container.

Further, the circuits, circuitry, systems, processors, microprocessors, processing systems, devices, processes, methods, techniques, functionality, services, servers, sources and the like described herein may be utilized, implemented and/or run on many different types of devices and/or systems. FIG. 21 illustrates an example system 2100 that may be used for implementing any of the components, circuits, circuitry, systems, functionality, apparatuses, processes, or devices of the container storage and retrieval system 100, and/or other above or below mentioned systems or devices, or parts of such circuits, circuitry, functionality, systems, apparatuses, processes, or devices. For example, the system 2100 may be used to implement some or all of the control circuit 130, mobile robots 110, workstations 106-107, 206, 706, 906, 1206, user computing systems, order management systems, inventory system, databases, delivery control system, and/or other such components, circuitry, functionality and/or devices. However, the use of the system 2100 or any portion thereof is certainly not required.

By way of example, the system 2100 may comprise one or more control circuits or processor resources 2112, one or more non-transitory memory 2114 storing one or more code sets executable by the one or more control circuits, and one or more communication links, paths, buses or the like 2118. Some embodiments may include one or more user interfaces 2116, and/or one or more internal and/or external power sources or supplies 2140. The control circuit 2112 can be implemented through one or more processors, microprocessors, ASIC, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 2112 can be part of control circuitry and/or a control system 2110, which may be implemented through one or more processors with access to one or more memory 2114 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 2100 may be used to implement one or more of the above or below, or parts of, components, circuits, systems, processes and the like.

The user interface 2116 can allow a user to interact with the system 2100 and receive information through the system. In some instances, the user interface 2116 includes a display 2122 and/or one or more user inputs 2124, such as buttons, touch screen, track ball, keyboard, mouse, etc., which can be part of or wired or wirelessly coupled with the system 2100. Typically, the system 2100 further includes one or more communication interfaces, ports, transceivers 2120 and the like allowing the system 2100 to communicate over a communication bus, a distributed computer and/or communication network (e.g., a local area network (LAN), the Internet, wide area network (WAN), etc.), communication link 2118, other networks or communication channels with other devices and/or other such communications or combination of two or more of such communication methods. Further the transceiver 2120 can be configured for wired, wireless, optical, fiber optical cable, satellite, or other such communication configurations or combinations of two or more of such communications. Some embodiments include one or more input/output (I/O) ports 2134 that allow one or more devices to couple with the system 2100. The I/O ports can be substantially any relevant port or combinations of ports, such as but not limited to USB, Ethernet, or other such ports. The I/O interface 2134 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 2126 to provide information to the system and/or sensor information that is communicated to another component, such as the control circuit 130, a server, robots, workstations, etc. The sensors can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, motion sensors, accelerometers, temperature sensors, proximity sensors, other such sensors or a combination of two or more of such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 2100 comprises an example of a control and/or processor-based system with the control circuit 2112. Again, the control circuit 2112 can be implemented through one or more processors, controllers, central processing units, logic, software and the like. Further, in some implementations the control circuit 2112 may provide multiprocessor functionality.

The memory 2114, which can be accessed by the control circuit 2112, typically includes one or more processor-readable and/or computer-readable media accessed by at least the control circuit 2112, and can include volatile and/or nonvolatile media, such as RAM, ROM, EEPROM, flash memory and/or other memory technology. Further, the memory 2114 is shown as internal to the control system 2110; however, the memory 2114 can be internal, external or a combination of internal and external memory. Similarly, some or all of the memory 2114 can be internal, external or a combination of internal and external memory of the control circuit 2112. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 2114 can store code, software, executables, scripts, data, content, lists, programming, programs, log or history data, user information, customer information, product information, and the like. While FIG. 21 illustrates the various components being coupled together via a bus, it is understood that the various components may actually be coupled to the control circuit and/or one or more other components directly.

Some embodiments provide an automated inventory management and/or container storage and retrieval systems, comprising: mobile robots configured to transport containers configured to support products; a storage structure accessible by the mobile robots, wherein the storage structure comprises multiple vertically spaced levels that each comprise multiple aisles, wherein each of the multiple aisles comprise storage locations configured to store a container of the containers; workstations cooperated with the storage structure and accessible by the mobile robots, wherein the workstations are spaced at different locations along the storage structure; and a first transit deck cooperated between the storage structure and a first workstation of the workstations, wherein the first transit deck comprises a planar surface upon which the mobile robots transport the containers establishing a planar route between the storage structure and the first workstation; wherein each of the workstations comprises: a first set of one or more substations positioned in a first orientation that is substantially parallel with a first axis of the storage structure, and a second set of one or more substations positioned in a second orientation that is different than the first orientation along a second axis that is at a first angle to the first axis of the storage structure, wherein each substation of the first and second sets of one or more substations comprises a respective access port accessible by the mobile robots and configured to enable a respective container, of the containers, to be exposed through each of the respective access ports allowing a product to be inserted and/or removed; and an access area defined by boundaries of both of the first set of substations and the second set of substations, with the first and second sets of one or more substations positioned such that each access port of the first and second sets of one or more substations are accessible by a picker from the access area.

The first transit deck can comprises a first section cooperated between the storage structure and the first set of one or more substations, a second section cooperated between the storage structure and the second set of one or more substations, and a third section cooperated between the storage structure and the third set of one or more substations. The first transit deck can extend between the first workstation and a second workstation, of the workstations, and wherein the first section, the second section, and the third section of the first transit deck are coupled together. One or more of the workstations can further comprise a third set of one or more substations oriented opposite the second set of one or more substations and along a third axis that is at a second angle to the first axis of the storage structure, wherein the third set of one or more substations comprises a third set of at least one access port accessible by the mobile robots and each configured to enable one of the containers to be exposed through the respective one of the third set of at least one access ports allowing the products to be inserted and/or removed. The access area can be defined between the first set of one or more substations, the second set of one or more substations and the third sets of one or more substations, with the first, second and third sets of one or more substations positioned such that each access port of the first, second and third sets of one or more substations are accessible by the picker from the access area. One or more workstations, in some embodiments, may be at least partially embedded into the storage structure such that the first transit deck extends at least partially within the storage structure at a first level, of the levels, and aligned with one or more of the aisles of the first level. Some embodiments additionally or alternatively comprise one or more workstations that are separated a distance from an exterior boundary of the storage structure. A first section of a transit deck can be cooperated between a one or more of the sets of one or more substations and the storage structure, and can extend along the first axis and along a portion of an exterior of the storage structure. A second section of the transit deck, in some embodiments, can be cooperated with the first section of the transit deck and can extend between a third set of one or more substations of a first workstation and a second set of one or more substations of a second workstation.

In some embodiments, one or more or each of the first, second and third sets of one or more substations of a workstation can comprise multiple station levels comprising a first station level and a second station level that is vertically separated from the first station level. A substation vertical channel can extend between the first station level and the second station level and can be configured to be used by the mobile robots to self-propel between the first station level and the second station level. The second set of one or more substations can, in some embodiments, comprise a first station aisle at the first station level and a second station aisle at the second station level. The first station aisle is configured to enable the mobile robots to travel along the first station level. The first set of access ports of the second set of one or more substations are, in some embodiments, positioned along at least a first portion of the second station aisle and accessible by the mobile robots while the mobile robots are positioned on the second station aisle. The second station aisle is configured to enable the mobile robots to travel along the second station level and align with any one of the first set of access ports and to move a first container, of the containers, to align with a first one of the first set of access ports. A third set of substations of a second workstation, of the workstations, can comprise a second set of access ports positioned along at least a second portion of the second station aisle and accessible by the mobile robots while the mobile robots are positioned on the second station aisle, wherein the second station aisle is configured to enable the mobile robots to align with any one of the second set of access ports and to move a third container, of the containers, align with a first one of the second set of access ports. The system can include a second transit deck that is vertically separated from the first transit deck; wherein the first transit deck is positioned at the first station level cooperated between a first level of the storage structure and the first station level; and wherein the second transit deck is positioned at the second station level cooperated between a second level of the storage structure and the second station level, wherein the second level of the storage structure is vertically separated from the first level of the storage structure.

Some embodiments provide methods of controlling inventory and fulfilling orders, comprising: identifying an allocation of products within a storage structure, the storage structure comprising: workstations are spaced at different locations along the storage structure, multiple vertically spaced levels that each comprise multiple aisles, wherein each of the multiple aisles comprise storage locations configured to store at least one container of containers; directing, by a control circuit, a first mobile robot, of mobile robots, to transport containers through the storage structure and to or from a first workstation, of the workstations cooperated with the storage structure and accessible by the mobile robots, wherein the first mobile robot: accessing and traveling along a first transit deck, comprising a planar surface, that is cooperated between the storage structure and the first workstation; and accessing a first access port of one of a first set of one or more substations positioned in a first orientation that is substantially parallel with a first axis of the storage structure and a second set of one or more substations positioned in a second orientation that is different than the first orientation along a second axis that is at a first angle to the first axis of the storage structure, and defining an access area bounded by both of the first set of substations and the second set of substations, with the first and second sets of one or more substations positioned such that each access port of the first and second sets of one or more substations are accessible by a picker from the access area, wherein each substation of the first and second sets of one or more substations comprises a respective access port that is accessible by the mobile robots and configured to enable a respective container, of the containers, to be exposed through each of the respective access ports allowing a product to be inserted and/or removed by the picker.

In some embodiments, one or more methods further comprises: directing, by the control circuit, a second mobile robot to travel from the first workstation to a second workstation, of the workstations, causing the second mobile robot to travel along the first transit deck extending between the first workstation and the second workstation. The directing the first mobile robot to access the first access port can comprise causing the first mobile robot to travel from the first level of the storage structure onto the first transit deck aligned with the first station level of the first substation, enter the first substation, move vertically to the second station level, travel along a second transit deck, which is vertically separated from the first transit deck, and travel from the second transit deck into a second level of the storage structure, wherein the second level of the storage structure is vertically separated from the first level of the storage structure. Some embodiments further comprise directing, by a control circuit, a second mobile robot of the mobile robots to transport a second container, of the containers, to a second access port of a second set of access ports of a second workstation causing the second mobile robot to: move to the second station aisle; travel along the second station aisle to the second access port, of the second set of access ports that are positioned along at least a second portion of the second station aisle and accessible by the second mobile robot while the second mobile robot is positioned on the second station aisle; and position the second container to at least partially align with the second access port of the second set of access ports of the second workstation enabling access through the second access port into the second container. In some embodiments, the method comprises directing, by the control circuit, a second mobile robot, of the mobile robots, to transport a second container, of the containers, from the first set of one or more substations of the first workstation to a second access port of a second set of one or more substations of a second workstation, of the workstations, and causing the second mobile robot to: travel along a first section of the first transit deck that is cooperated between the first set of one or more substations and the storage structure and extends along the first axis and along a portion of an exterior of the storage structure; and move from the first section to the first transit deck to a second section of the first transit deck and access the second access port of the second set of one or more substations of the second workstation; wherein the first transit deck extends between the third set of one or more substations of the first workstation and the second set of one or more substations of the second workstation.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. An automated container storage and retrieval system, comprising:
mobile robots configured to transport containers configured to support products;
a storage structure accessible by the mobile robots, wherein the storage structure comprises multiple vertically spaced levels that each comprise multiple aisles, wherein each of the multiple aisles comprise storage locations configured to store a container of the containers;
workstations cooperated with the storage structure and accessible by the mobile robots, wherein the workstations are spaced at different locations along the storage structure; and
a first transit deck cooperated between the storage structure and a first workstation of the workstations, wherein the first transit deck comprises a planar surface upon which the mobile robots transport the containers establishing a planar route between the storage structure and the first workstation;
wherein each of the workstations comprises:
a first set of one or more substations positioned in a first orientation that is substantially parallel with a first axis of the storage structure, and a second set of one or more substations positioned in a second orientation that is different than the first orientation along a second axis that is at a first angle to the first axis of the storage structure, wherein each substation of the first and second sets of one or more substations comprises a respective access port accessible by the mobile robots and configured to enable a respective container, of the containers, to be exposed through each of the respective access ports allowing a product to be inserted and/or removed; and
an access area defined by boundaries of both of the first set of one or more substations and the second set of one or more substations, with the first and second sets of one or more substations positioned such that each access port of the first and second sets of one or more substations are accessible by a picker from the access area.

2. The automated order fulfillment system of claim 1, further comprising:
a third set of one or more substations oriented opposite the second set of one or more substations and along a third axis that is at a second angle to the first axis of the storage structure, wherein the third set of one or more substations comprises a third set of at least one access port accessible by the mobile robots and each configured to enable one of the containers to be exposed through the respective one of the third set of at least one access ports allowing the products to be inserted and/or removed; and
the access area defined between the first set of one or more substations, the second set of one or more substations and the third sets of one or more substations, with the first, second and third sets of one or more substations positioned such that each access port of the first, second and third sets of one or more substations are accessible by the picker from the access area.

3. The system of claim 2, wherein the first workstation is positioned beyond an exterior boundary and outside of the storage structure such that the first transit deck extends at least partially outside of the storage structure between the storage structure and the first workstation.

4. The system of claim 2, wherein the first workstation is at least partially embedded into the storage structure such that the first transit deck extends at least partially within the storage structure at a first level, of the levels, and aligned with one or more of the aisles of the first level.

5. The system of claim 2, wherein the second set of one or more substations and the third set of one or more substations are positioned within the storage structure.

6. The system of claim 2, wherein the first transit deck comprises:
a first section cooperated between the storage structure and the first set of one or more substations;
a second section cooperated between the storage structure and the second set of one or more substations; and
a third section cooperated between the storage structure and the third set of one or more substations.

7. The automated storage and retrieval system of claim 2, wherein each of the first, second and third sets of one or more substations comprise:
multiple station levels comprising a first station level and a second station level that is vertically separated from the first station level; and
a substation vertical channel extending between the first station level and the second station level and configured to be used by the mobile robots to self-propel between the first station level and the second station level.

8. The system of claim 7, wherein one or more access ports of each of the first set of one or more substations is positioned at the second station level and oriented such that the mobile robots are configured to move from the first station level to the second station level and to position a respective one of the containers to at least partially align with the respective access port while the respective one of the containers remains on the respective mobile robot as the respective mobile robot moves through the respective substation of the first set of one or more substations.

9. The system of claim 7, wherein each of the access ports of a first set of access ports of the second set of one or more substations is configured to receive a respective one of the containers moved into a respective one of the first set of access ports and released by a respective one of the mobile robots such that the respective container does not remain on the respective one of the mobile robots while the respective container is accessible through the respective one of the first set of access ports.

10. The system of claim 7, wherein the second set of one or more substations comprises a first station aisle at the first station level, wherein the first station aisle is configured to enable the mobile robots to travel along the first station level;
wherein the second set of one or more substations comprises a second station aisle at the second station level, wherein a first set of access ports are positioned along at least a first portion of the second station aisle and accessible by the mobile robots while the mobile robots are positioned on the second station aisle, wherein the second station aisle is configured to enable the mobile robots to travel along the second station level and align with any one of the first set of access ports and to move a first container, of the containers, to align with a first one of the first set of access ports.

11. A method of controlling inventory, comprising:
identifying an allocation of products within a storage structure, the storage structure comprising: workstations are spaced at different locations along the storage structure, multiple vertically spaced levels that each comprise multiple aisles, wherein each of the multiple aisles comprise storage locations configured to store at least one container of containers;
directing, by a control circuit, a first mobile robot, of mobile robots, to transport containers through the storage structure and to or from a first workstation, of the workstations cooperated with the storage structure and accessible by the mobile robots, wherein the first mobile robot:
accessing and traveling along a first transit deck, comprising a planar surface, that is cooperated between the storage structure and the first workstation; and
accessing a first access port of one of a first set of one or more substations positioned in a first orientation that is substantially parallel with a first axis of the storage structure and a second set of one or more substations positioned in a second orientation that is different than the first orientation along a second axis that is at a first angle to the first axis of the storage structure, and defining an access area bounded by both of the first set of one or more substations and the second set of one or more substations, with the first and second sets of one or more substations positioned such that each access port of the first and second sets of one or more substations are accessible by a picker from the access area, wherein each substation of the first and second sets of one or more substations comprises a respective access port that is accessible by the mobile robots and configured to enable a respective container, of the containers, to be exposed through each of the respective access ports allowing a product to be inserted and/or removed by the picker.

12. The method of claim 11, further comprising:
a third set of one or more substations oriented opposite the second set of one or more substations and along a third axis that is at a second angle to the first axis of the storage structure,
wherein the third set of one or more substations comprises a third set of at least one access port accessible by the mobile robots and each configured to enable one of the containers to be exposed through the respective one of the third set of at least one access port allowing the products to be inserted and/or removed; and
the access area defined between the first set of one or more substations, the second set of one or more substations and the third sets of one or more substations with the first, second and third sets of one or more substations positioned such that each access port of the first, second and third sets of one or more substations are accessible by the picker from the access area.

13. The method of claim 12, further comprising:
directing the first mobile robot to access the first access port comprises causing the first mobile robot to travel along the first transit deck beyond an exterior boundary of and outside of the storage structure, wherein the first transit deck extends at least partially outside of the storage structure between the storage structure and the first workstation.

14. The method of claim 12, wherein the directing the first mobile robot to the first workstation comprises directing the first mobile robot to the first workstation that is at least partially embedded into the storage structure such that the first transit deck extends at least partially within the storage structure at a first level, of the levels, and aligned with one or more of the aisles of the first level.

15. The method of claim 12, further comprising:
directing the first mobile robot to access the first access port comprises directing the first mobile robot to access the first access port of one of the second set of one or more substations and the third set of one or more substations that are positioned within the storage structure.

16. The method of claim 12, wherein the directing the first mobile robot to access the first access port comprises causing the first mobile robot to travel along at least one of:
a first section of the first transit deck cooperated between the storage structure and the first set of one or more substations;
a second section of the first transit deck cooperated between the storage structure and the second set of one or more substations; and
a third section of the first transit deck cooperated between the storage structure and the third set of one or more substations.

17. The method of claim 12, wherein the directing the first mobile robot to access the first access port comprises causing the first mobile robot to enter a first station level of a first substation, of the first set of one or more substations, access a substation vertical channel, of the first substation, that extends between the first station level and a second station level of the first substation, and self-propel vertically along the substation vertical channel between the first station level and the second station level, wherein the second station level is vertically separated from the first station level.

18. The method of claim 17, wherein the directing the first mobile robot to access the first access port comprises causing the first mobile robot to move from the first station level to the second station level and to position a respective one of the containers to at least partially align with the first access port while the respective one of the containers remains on the first mobile robot.

19. The method of claim 17, wherein the directing the first mobile robot to access the first access port comprises causing the first mobile robot to release the respective container into a first substation of the second set of one or more substations such that the respective container does not remain on the first mobile robot while the respective container is accessible through the first access port.

20. The method of claim 17, wherein the directing the first mobile robot to access the first access port comprises causing the first mobile robot to enter a first station aisle, of the second set of one or more substations, at the first station level and travel along the first station aisle; vertically move to a second station aisle at the second station level; travel along the second station level and align with the first access port, of a first set of access ports that are positioned along at least a first portion of the second station aisle and accessible by the mobile robots while the mobile robots are positioned on the second station aisle; and move the respective container to at least partially align with the first access port.
